(19) United States
(12) Patent Application Publication
(10) Pub. No.: US 2012/0319329 A1
(43) Pub. Date: Dec. 20, 2012

(54) Systems and Methods for Self-Assembling Ordered Three-Dimensional Patterns By Buckling Of Thin Films Bonded To Curved Compliant Substrates

(75) Inventor: Xi Chen, New York, NY (US)

(73) Assignee: The Trustees of Columbia University in the City of New York, New York, NY (US)

(21) Appl. No.: 13/452,441

(22) Filed: Apr. 20, 2012

Related U.S. Application Data
(63) Continuation of application No. PCT/US2010/053544, filed on Oct. 21, 2010.
(60) Provisional application No. 61/253,755, filed on Oct. 21, 2009.

(51) Int. Cl. B29C 53/02; B29C 59/02

(52) U.S. Cl. 264/320; 425/352

(57) ABSTRACT

Self-assembled buckling patterns of thin films on compliant substrates can be used in micro-fabrication. However, most previous work has been limited to planar substrates, and buckling of films on curved substrates has not been widely explored. With the constraining effect from various types of substrate curvature, numerous new types of buckling morphologies can be derived. The morphologies not only enable true three-dimensional (3D) fabrication of microstructures and microdevices, but also can have important implications for the morphogenesis of quite a few natural and biological systems.

### CROSS REFERENCE TO RELATED APPLICATIONS

This application is a continuation of International Patent Application No. PCT/US10/053,544 filed Oct. 21, 2010 and published on Apr. 28, 2011 as International Patent Publication No. WO/2011/050161, and claims priority to U.S. Provisional Patent Application Ser. No. 61/253,755, filed on Oct. 21, 2009, the entirety of the disclosures of both of which are explicitly incorporated by reference herein and from which priority is claimed.

### STATEMENT REGARDING FEDERALLY SPONSORED RESEARCH

This invention was made with government support under Grant CMMI-CAREER-0643726 awarded by the National Science Foundation. The government has certain rights in the invention.

### BACKGROUND

Self-assembled buckling of thin films on compliant substrates can achieve highly ordered patterns when the film deformation mismatches with that of the substrate, which can be applied in stretchable interconnects, flexible integrated circuits, optical gratings, measuring the film modulus, and producing a wrinkled substrate to control the direction of cell growth, among others.

When a thin metal film of submicron thickness is deposited on a planar PDMS substrate, for example, spontaneous elastic buckling patterns can be observed in the film as the arrangement is cooled, owing to the mismatched thermal deformation with typical wavelengths on the micron level. The substrate surface topology can be manipulated to change the local film stress so as to generate a variety of ordered patterns. Similarly, local physical properties of the thin film can be perturbed to arrive at various buckle patterns. Nanoscale patterns can be achieved by modifying the surfaces using a focused ion beam. External constraints can be applied where a pre-patterned mold is held against the film as the buckles are formed. The resulting pattern is stable after the removal of the mold. The substrate can also be pre-strained, where silicon nano-ribbons bonded to a pre-stretched flat polymer such as PDMS can generate wavy layouts upon releasing the substrate strain.

### SUMMARY

Techniques for buckling of thin films bonded to curved compliant substrates are described.

Some embodiments of the described subject matter include techniques for creating and self-assembling a three-dimensional buckle pattern in a film having at least one deformation property and bonded to a substrate having at least one deformation property which is different than the at least one film deformation property including a receptacle for receiving the substrate and bonded film and a buckling component, coupled to the receptacle and configured to alter the at least one deformation property of the substrate and/or the at least one deformation property of the film according to one or more tunable parameters, to thereby cause the film to buckle in a three dimensional pattern. The shape of the substrate can include a curved plane, cylinder, sphere, spheroid, cone, and combinations thereof. The buckling component can be configured to alter the at least one deformation property of the substrate and/or the at least one deformation property of the film by one or more of differential growth, thermal expansion mismatch, electric field-responsive deformation mismatch, phase transformation-induced strain mismatch, swelling or dehydration mismatch, osmotic pressure, and environmental pH variation. The techniques can include a parameter component configured to set the one or more tunable parameters, wherein the one or more tunable parameters include buckling stress, buckling amplitude, buckling shape, and buckling wavelength. The three-dimensional ordered buckle pattern can spontaneously form a three-dimensional structure that is selected from the group consisting of a gear and a coil. The buckle pattern can increase the wetting properties of a nanopore.

### BRIEF DESCRIPTION OF THE DRAWINGS

FIG. 1 illustrates some embodiments including an illustration of the effect of substrate curvature (t/R) on the pre-buckling stress of thin films on cylindrical and spherical substrates with different film/substrate modulus mismatch (E_{f}/Eₛ).

FIG. 2 illustrates some embodiments including the normalized buckling wavelength as a function of film/substrate stiffness mismatch, presented for different curvatures of the cylindrical substrate and compared with the planar counterparts under uniaxial and equi-biaxial compression.

FIG. 3 illustrates some embodiments including mechanical self-assembly of gear-like profiles via spontaneous buckling of films on curved cylindrical substrates. (a) includes an illustration of two spur gears self-assembled on shallow cylindrical substrates (with low aspect ratio L/R), the smaller one with R/t=125 and Ē_{f}/Ēₛ=1516, and the larger one with R/t=250 and Ē_{f}/Ēₛ=1273. The relevant FEM demonstration is shown. (b) includes an illustration of bevel gears with the smaller radius Rₗ/t=150, aspect ratio L/Rₗ=0.4, cone apex angle 90°, and Ē_{f}/Ēₛ=1273. The matching FEM demonstration is shown. (c) illustrates a gear formed on the external surface of a hollow cylindrical substrate. (d) illustrates a gear formed on the internal surface of an annular cylindrical substrate. (e) illustrates a high aspect ratio gear, which is similar to the gear-like profile formed on a microscale cylindrical substrate with M=1500 and Ē_{f}/Ēₛ=100. (f) illustrates wrinkled surface topologies with longitudinal grooves observed on a long electrospun polymer micro-fiber. The inset shows the wrinkled cross-section profile.

FIG. 4 illustrates some embodiments including morphologies of gears with 3D features induced by anisotropic properties.

FIG. 5 illustrates some embodiments including a global instability mode of several long cylindrical shell/core structures. For nanofibers, (a) illustrates nanofibers with a stiff shell and a soft core structure produced by coaxial electrospinning. With excessive shrinkage of the core, the axial compressive stress in the shell triggers the global buckling of the nanofibers into (b) nanosprings if the core size is comparable with the shell thickness and (c) nanocoils if the shell is thinner. For tissues, (d) illustrates arterial tortuosity or kinking induced by bending buckling, (e) coiling of a human internal carotid artery. Similar coiling morphology is also often observed in (f) plant tendrils and (g) natural hair, among others.

FIG. 6 illustrates some embodiments including a comparison between spherical and cylindrical substrates from FEM demonstrations.

FIG. 7 illustrates some embodiments including some demonstrations of self-assembly on spherical shell/core arrangements. For solid inorganic arrangements, (a) illustrates a demonstration of a reticular pattern formed on a spherical arrangement (SiO₂ film/Ag substrate), with R/t=20 and Ē_{f}/Ēₛ=5. (b) illustrates microlens arrays self-assembled on a hemispherical soft substrate using constrained local buckles. (c) illustrates interconnected silicon ribbon-like photodetectors on a hemispherical elastomer substrate. (d) illustrates nanoscale hexagonal pattern self-assembled on a stable microbubble, which is in part due to (e) differential shrinkage induced buckling of the bubble surface and (f) the pattern strongly influenced by the bubble curvature.

FIG. 8 illustrates the morphogenesis of some cells and tissues that can be related to the wrinkling instability of nearly spherical shell/core arrangements. For cells, (a) illustrates a wrinkled bacterial cell, owing to the relative shrinkage of the cytoplasm under hyper-osmotic pressure. (b) illustrates a wrinkled human neutrophil cell due to the relative expansion of the cell membrane surface area during cell growth or phagocytosis. (c) illustrates a wrinkled cell nucleus due to hyper-osmotic shrinkage, and (d) illustrates embodiments where the wrinkles can disappear with the swelling of nucleoplasm under hypo-osmotic pressure. For the folding pattern of the brain cortex, (e) the surface is relatively smooth in the fetus period yet (f) it folds into a pattern with bumps and grooves during growth. The cross-section view of brain cortex shows that (g) during the early stage, the surface is relatively smooth, and (h) during the later stage, the wrinkled morphology is observed.

FIG. 9 illustrates some embodiments including a deformation map of spheroidal shell/core arrangement s as the three geometrical parameters are varied.

FIG. 10 illustrates some embodiments including morphogenesis of spheroidal-like natural and biological arrangements, where in each example, the observation (larger picture) matches reasonably with the demonstration based on the simple spheroidal shell/core model (smaller picture).

FIG. 11 illustrates some embodiments including wrinkling of water-immersed fingertips (a-c) and associated models (d-f).

FIG. 12 illustrates some embodiments including postulated interactions among mechanics, morphogenesis, and fabrication.

FIG. 13 illustrates an exemplary schematic of a gradient thin film on a compliant substrate with film thickness gradient (top) or modulus gradient (bottom).

FIG. 14 illustrates some embodiments where the loading direction is normal to the gradient direction and illustrates FEM demonstrations of buckling profiles. (a) illustrates a film with thickness gradient coefficient at=0.5, where Y-junction channels are formed. (b) illustrates the corresponding buckling wavelength measured along the gradient direction of FIG. 17a. (c) illustrates a film with combination of thickness gradients, where the upper half has uniform thickness with at1=0 and the lower half has a thickness gradient with at2=0.67; in this case, two junction-shaped channels are formed. (d) illustrates a film with modulus gradient coefficient aE=0.9.

FIG. 15 illustrates some embodiments where the loading direction is parallel to the gradient direction. (a) illustrates FEM demonstrations of buckling profiles of gradient films with either a decreasing or with an increasing level of compression; the x-axis is x/L. (b) illustrates an embodiment where the effect of the gradient coefficient a (thickness or modulus gradient) on the effective buckling wave number m_{cr} when the normalized effective substrate stiffness is varied. (c) illustrates an embodiment illustrating the effect of a on the normalized critical buckling force. (d) illustrates an embodiment illustrating the effect of a on the normalized effective buckling amplitude.

FIG. 16 illustrates some embodiments of the wrinkle processes of fingertips of a young Asian male immersed in water.

FIG. 17 illustrates some embodiments of the described subject matter including the reduced finger model.

FIG. 18 illustrates some embodiments of the described subject matter including a comparison between the prediction and the FEM demonstration of the reduced model.

FIG. 19 illustrates some embodiments including the full fingertip model. The embodiment illustrated in (a) shows the section of a finger with a five-layered structure: SC (golden color), viable epidermis (black color), dermis (white color), subcutaneous tissues (grey color) and bone (dark color). The embodiment illustrated in (b) depicts a validation test of the full finger model with other models under a 50 μm line load. The embodiment in (c) illustrates an embodiment where the grey region of the fingertip is allowed to swell. The embodiment in (d) shows a result of a wrinkled finger (=1:10) with the material and geometrical parameters given in Table 1.

FIG. 20 illustrates some embodiments including (a) a comparison between the reduced model and the full model on the wrinkle wavelength where the Young's modulus of respective layer is changed from half to double its initial value in Table 1, while other layers are kept unchanged; (b) deformation of the finger cross-section as the modulus of the respective layer is varied by either half or double its original value.

### DETAILED DESCRIPTION

Self-assembled buckling patterns of thin films on compliant substrates can be used in micro-fabrication. However, most previous work has been limited to planar substrates, and buckling of films on curved substrates has not been widely explored. With the constraining effect from various types of substrate curvature, numerous new types of buckling morphologies can be derived. The morphologies not only enable true three-dimensional (3D) fabrication of microstructures and microdevices, but also can have important implications for the morphogenesis of quite a few natural and biological systems.

Some embodiments illustrate buckling patterns of thin films on curved compliant substrates with applications to morphogenesis and three-dimensional micro-fabrication.

The mechanics and physics governing the elastic buckling patterns of thin films on curved compliant substrates with a special emphasis on the effect of substrate curvature will be described.

Consider a curved substrate with Young's modulus Eₛ and Poisson's ratio vₛ, and a thin film of thickness t, Young's modulus E_{f} (Eₛ/E_{f}<<1) and Poisson's ratio v_{f} is bonded to the substrate in the due course of buckling; both the film and substrate are assumed to be homogeneous, isotropic and elastic unless otherwise denoted. The mismatched deformation between the film and substrate can be induced in various ways, including differential growth, thermal expansion mismatch, electric field-responsive deformation mismatch, phase transformation-induced strain mismatch, swelling or dehydration mismatch, osmotic pressure, environmental pH variation, etc., such that either the substrate shrinks more than the film or the film expands more than the substrate. As a result, the film can be compressed. When such a stress exceeds the threshold, spontaneous buckles can occur with a distinct pattern. If the stress field in the film is anisotropic and inhomogeneous (which can be caused by the effect of substrate curvature), buckles are likely to occur in the regions with more prominent stress and align in preferred directions so as to relieve the strain energy more effectively. Two parameters for characterizing the buckles are the critical buckling stress and buckling wavelength.

For the case where the substrate is planar (and semi-infinite), when the arrangement undergoes equi-biaxial compression, the herringbone pattern can emerge. The critical buckling wavelength and critical stress are:

$${\overline{λ}}_{cr}^{equi} = 2 π {t ( \frac{{\overline{E}}_{f}}{3 {\overline{E}}_{s}} )}^{\frac{1}{3}} and {\overline{σ}}_{cr}^{equi} = \frac{1}{4} {( 9 {\overline{E}}_{s}^{2} {\overline{E}}_{f} )}^{\frac{1}{3}} \qquad ( 1 )$$

respectively, where Ē_{f}=E_{f}/(1−v_{f}²) and Ēₛ=Ēₛ/(1−vₛ²). If the compression is uniaxial the corresponding parameters are:

$${\overline{λ}}_{cr}^{uni} = 2 π t {Ω ( \frac{{\overline{E}}_{f}}{{\overline{E}}_{s}} )}^{\frac{1}{3}} and {\overline{σ}}_{cr}^{uni} = {Ξ ( {\overline{E}}_{s}^{2} {\overline{E}}_{f} )}^{\frac{1}{3}} \qquad ( 2 )$$

$$where$$

$$Ω = {[ ( 3 - 4 {v}_{s} ) {( 1 - {v}_{s} )}^{2} / 12 ]}^{\frac{1}{3}} and$$

$$Ξ = {3 [ 12 {( 3 - 4 {v}_{s} )}^{2} / {( 1 - {v}_{s} )}^{4} ]}^{\frac{1}{3}} .$$

One approach to incorporating the substrate curvature effect is to introduce a uniform curvature along one direction of the initial planar substrate. In this case, the substrate becomes cylindrical. The geometry of a cylindrical-like shell/core structure is often found in micro/nanowires, fibers, plant stems, animal bodies, as well as in some tissues such as arteries and collagen fibers. When the principal curvature is uniform in all directions, the spherical substrate, which is widely observed in bubbles, the brain cortex, cells, and the nucleus, etc., can have interesting properties. The spheroidal substrate, which can be regarded as a modification of the spherical one, is a good approximation of quite a few fruits, vegetables, eggs, etc. Finally, when the cylindrical substrate is combined with a spherical cap, a model fingertip emerges and its wrinkling pattern upon water immersion can be interesting. In what follows, for each representative type of substrate, the interaction and coupling between the substrate curvature effect and other material and arrangement variables, the ways to control the characteristics of buckles, as well as the potential applications and implications of these self-assembly buckling patterns on curved substrates in morphogenesis and three-dimensional fabrications can be demonstrated.

Some embodiments illustrate cylindrical substrates. Consider a long cylindrical substrate with radius R (R/t>>1) and length L, whose lateral surface is completely covered by the film. In such a plane-strain arrangement with the increase of the mismatched deformation between the film and substrate, the hoop stress in the film will build up. Denote the magnitude of the unconstrained strain mismatch between the film and substrate as Δε. For instance, upon thermal expansion mismatch, let the coefficient of thermal expansion (CTE) of the film and substrate to be α_{f} and αₛ, respectively, then Δε=|α_{f}−αₛ|ΔT, where in case α_{f}<αₛ, ΔT, is the temperature drop during cooling, and in case α_{f}>αₛ, ΔT is the temperature increase during heating. Similarly, for growth, swelling, or dehydration mismatch, one can replace α_{f} and αₛ by the respective growth coefficients, and ΔT by the effective growth time. The magnitude of film stress in the pre-buckling state is

$${σ}_{f 0} = \frac{{E}_{f} {E}_{s} ( 2 {R}^{2} + 2 Rt + {t}^{2} ) Δɛ}{\begin{matrix}2 {E}_{s} ( 1 - {v}_{f}^{2} ) {R}^{2} + [ {E}_{s} ( 1 + {v}_{f} ) + {E}_{f} ( 1 + {v}_{s} ) ( 1 - 2 {v}_{s} ) ] \\ ( 2 Rt + {t}^{2} )\end{matrix}} \qquad ( 3 )$$

Eq. (3) is valid for film/shell of any thickness; for thin film, the higher order terms related to t² can be omitted.

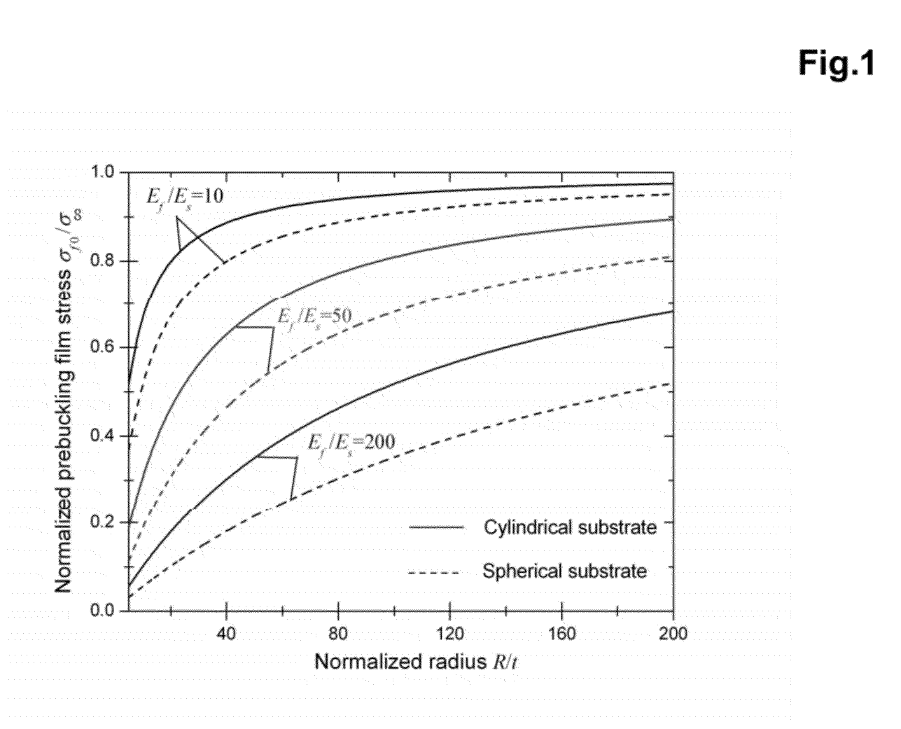

In FIG. 1, the pre-buckling stress is normalized by its counterpart for planar substrate of respective scenarios.

FIG. 1 gives the variation of σ_{f0}/σ_{∞}, as a function of R/t, for several different E_{f}/Eₛ values (the Poisson's ratio for both substrate and film is assumed to be 0.35 unless otherwise denoted). Here, σ_{∞}=Ē_{f}Δε is the limit for planar substrate (i.e., when R/t→∞ in Eq. (3)). It can be seen that if E_{f}/Eₛ is relatively small, with the increase of the substrate radius of curvature R/t, the film stress quickly approaches to the planar limit, whereas the convergence is much slower when the film is much stiffer than the substrate; that is, the substrate curvature effect is coupled with the elastic mismatch effect.

When σ_{f0} exceeds a critical value, the film will buckle. The critical buckling wavelength can be obtained from a simplified plane-strain ring-foundation model, where the exact solution of the corresponding wrinkle wave number n_{cr} can be given by minimizing the following equation with respect to n

$${p}_{n} = \frac{{\overline{E}}_{f} I ( 1 + \overline{K} )}{{R}^{3}} \frac{[ {( {n}^{2} - 1 )}^{2} + \overline{K} ( 1 + {AR}^{2} / I ) ]}{[ {n}^{2} - 1 + \overline{K} - ( \overline{K} + {\overline{K}}^{2} ) / {n}^{2} ]} \qquad ( 4 )$$

where pₙ is the critical bifurcation line pressure of the nth mode, A and I are the area and moment of inertia of the cross-section of the film, respectively; K̅=ĒₛR/Ē_{f}t is the dimensionless Winkler foundation stiffness where \tilde{E}ₛ=Eₛ/(1−2vₛ)(1+vₛ). If the substrate is inhomogeneous, e.g., containing a stiff or compliant core, then K̅ can be revised accordingly and Eq. (4) is still valid. For instance, if the substrate contains an empty core with radius α, then

$$\overline{K} = \frac{{\overline{E}}_{s} R}{{\overline{E}}_{f} t} {( \frac{{R}^{2} + {α}^{2}}{{R}^{2} - {α}^{2}} - \frac{{v}_{s}}{1 - {v}_{s}} )}^{- 1} .$$

*For spherical substrate, as R/t→∞ in Eq. (8), the limit is σ_{∞}, =E_{f}Δε/(1−v_{f}) and that is applied to FIG. 1 for normalizing the dash curves. The exact solution of n_{cr}, however, must be derived numerically. Instead, one can simplify Eq. (4) by assuming that K̅ is small compared with n, and thus the reduced solution of the critical buckling wave number n_{cr}, wavelength \hat{λ}_{cr}, and critical stress \hat{σ}_{cr} can be derived in closed-form:

$${n}_{cr} = {( \frac{R}{t} )}^{\frac{3}{4}} {( \frac{12 {\tilde{E}}_{s}}{{\overline{E}}_{f}} )}^{\frac{1}{4}} , {\hat{λ}}_{cr} = \frac{2 π R}{{n}_{cr}} = 2 π {t ( \frac{R}{t} )}^{\frac{1}{4}} {( \frac{{\overline{E}}_{f}}{12 {\tilde{E}}_{s}} )}^{\frac{1}{4}} and \\ {\hat{σ}}_{cr} = {( \frac{{\overline{E}}_{f} {\tilde{E}}_{s}}{3} )}^{\frac{1}{2}} {( \frac{t}{R} )}^{\frac{1}{2}} \qquad ( 5 )$$

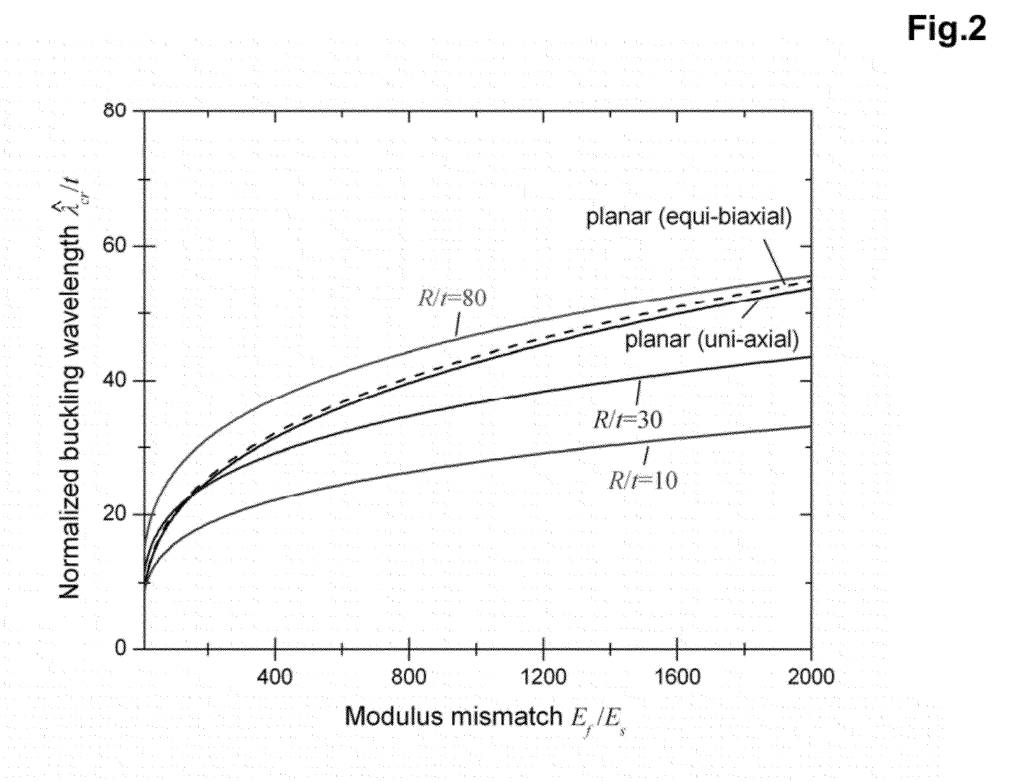

Comparing Eq. (5) with Eqs. (1) and (2), the effect of substrate curvature t/R on buckling characteristics is obvious. FIG. 2 shows that for a planar substrate, the critical buckling wavelength is almost the same under uni-axial and equi-biaxial compressions. Since the cylindrical film is closed, as R/t is increased, its wavelength does not necessarily converge to the planar solution. For both planar and cylindrical substrates, the buckling wavelength increases with the modulus mismatch E_{f}/Eₛ and t. However, the wavelength of the curved substrate also depends on the normalized curvature and it increases with Wt. Moreover, for planar substrates, the critical buckling stress is independent of the film thickness, whereas t also affects the bifurcation of cylindrical film/substrate arrangements through the term Wt. Such a qualitative comparison illustrates the importance of the substrate curvature.

The buckle amplitude A can be obtained from the deformation compatibility between the film and substrate, which is given by

$$\frac{A}{t} = {[ \frac{2}{3} ( \frac{{σ}_{f}}{{\hat{σ}}_{cr}} - 1 ) ]}^{\frac{1}{2}} = {[ \frac{2}{3} ( \frac{{ɛ}_{f}}{{\hat{ɛ}}_{cr}} - 1 ) ]}^{\frac{1}{2}} \qquad ( 6 )$$

where σ_{f} and ε_{f} are the film stress and strain in the buckled state, respectively. \hat{ε}_{cr}=(\tilde{E}ₛt/3Ē_{f}R)^{1/2} is the critical buckling strain. Although the format of Eq. (6) is similar to that of thin film on a planar substrate, the effect of substrate curvature is implicitly embedded in the terms ε_{f} and \hat{ε}_{cr}.

The explicit equations (5) and (6) have been validated by demonstrations based on the finite element method (FEM). They provide the basis for mechanical self-assembly of ordered patterns on cylindrical substrates, in particular gear-like profiles whose geometrical properties (gear teeth number and teeth amplitude) can be controlled precisely via the adjustment of material property, substrate geometry, film thickness, and degree of mismatched deformation. For example, in order to increase the teeth number, one should increase R/t or decrease E_{f}/Eₛ. The later technique can be applied if the size of the gear is fixed. If one wishes to reduce the critical buckling threshold such that the gear profile emerges more easily on the cylindrical substrate, then R/t and/or E_{f}/Eₛ scan be increased. To enhance the teeth amplitude, in addition to increase Δε, one can also reduce the critical buckling threshold by increasing R/t and/or E_{f}/Eₛ.

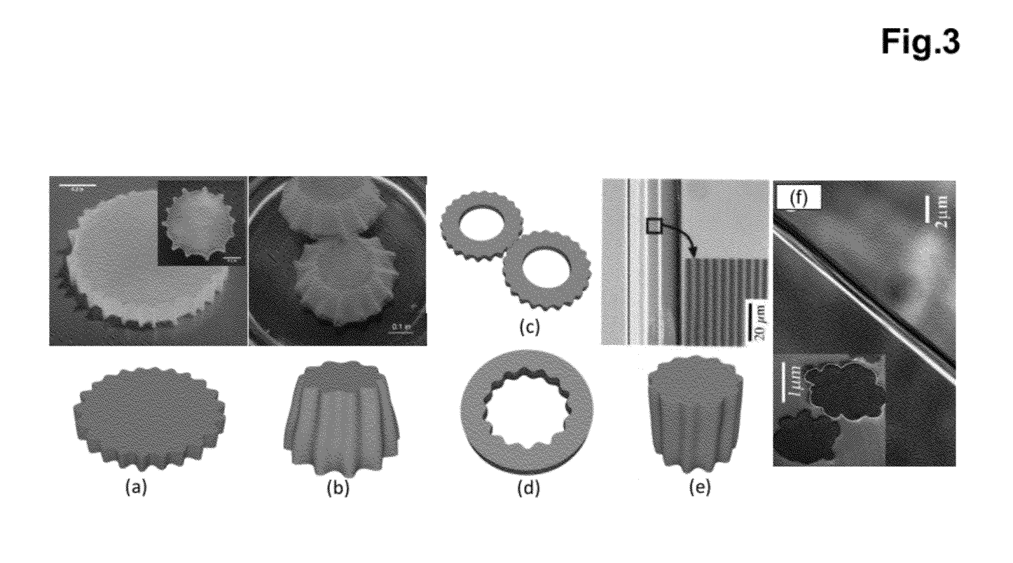

A demonstration has been performed where a polyvinyl chloride (PVC) film (t=50 μm) was bonded on the lateral surface of a cylindrical polyurethane substrate (R=1-6 mm). Upon dehydration of the substrate, the gear-like buckling profile emerged whose wavelength followed closely of that in Eq. (5) (and remain unchanged during the process), and the teeth amplitude increased nonlinearly with time (or the mismatch strain, Eq. (6)). In FIGS. 3a and 3b, demonstrations on spur gear and bevel gear are illustrated.

For FIG. 3, the top row (left to right) illustrates the effect of anisotropic growth where the mismatched strain in the axial direction is 1.5, 2, and 2.5 times that in the hoop direction. The bottom row illustrates inclined gears formed by buckling of an orthotropic film on a cylindrical substrate, where the material anisotropy axes (1, 2) are misaligned with the principal curvature axes (θ, z) of the substrate. The resulting gear pattern examples show different teeth inclination angles and different aspect ratios.

The demonstrated new mechanical self-assembly technique using soft materials also has the additional advantage of biocompatibility for potential biomedical applications.

Using the same principle, wrinkles can also be created on a hollow substrate (FIG. 3c), or the internal surface of an annular cylindrical substrate (FIG. 3d), as well as fabricating a high aspect ratio gear (FIG. 3e). In the case of the high aspect ratio gear (FIG. 3e), the illustrated profile is also qualitatively consistent with other demonstrations on a cylindrical substrate at the micron-scale, where the thin film was obtained by oxidation of the surface of the elastic polymer substrate and the uniform film buckling pattern was induced by thermal expansion mismatch.

In addition to potential applications in micro-machines and soft machines, the gear-like wrinkled surface morphologies can largely increase the surface area of micro or nanofibers and modify their wetting properties. For example, wrinkled surface topographies are often observed in electrospun polymer micro-fibers as shown in FIG. 3f. During solvent evaporation, a glassy thin film formed on the soft cylindrical substrate, and the relative shrinkage of the substrate resulted in the wrinkled morphologies. As revealed in the surface structure of water spider legs, the microsetae with fine nanoscale axial grooves account for its remarkable water repellence. Using spontaneous buckles formed on micro and nanofibers, similar axial grooves can be engineered with tunable wavelengths and amplitudes (following the mechanical principles, Eqs. (5) and (6)), enabling the design of superhydrophobic micro and nano structures.

In essence, with the underlying cylindrical substrate, the hoop stress developed in the film is about two times the axial stress, and thus the initial bifurcation makes the wrinkles parallel to the axial direction like those in FIG. 3. To break the axisymmetry and create true 3D patterns on cylindrical substrates, anisotropy is needed.

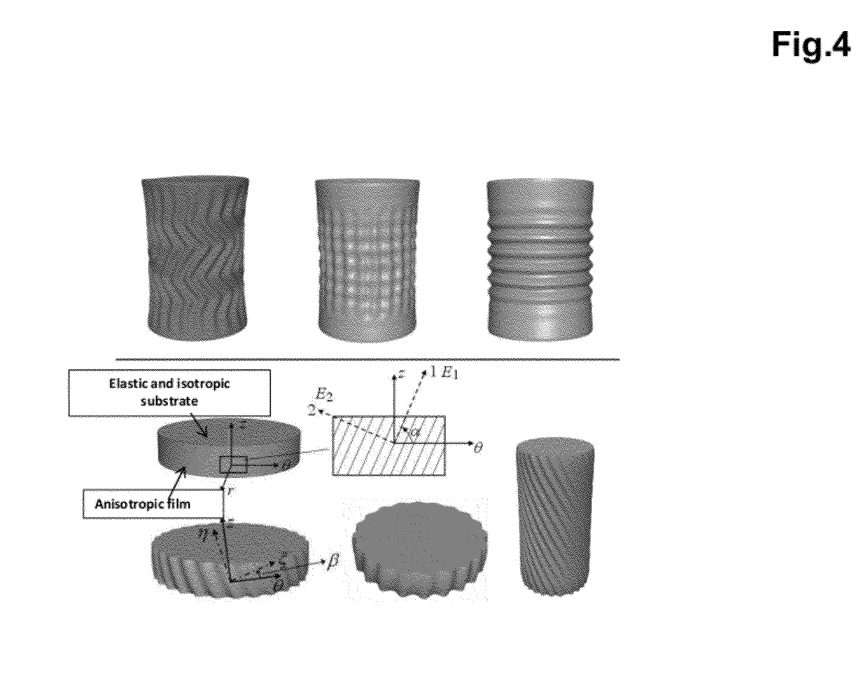

In some embodiments, described is anisotropic film and implication for 3d fabrication. If one can make the axial stress to be comparable or even higher than the hoop stress, then the circumferential wrinkles would appear. This requires anisotropy such that either the mismatched deformation in the axial direction is much larger than that in the hoop direction, or the film stiffness in the axial direction is much smaller than that in the hoop axis. For instance, if the mismatched strain Δε in the axial (longitudinal) direction is 1.5, 2, or 2.5 times that in the hoop direction, numerical demonstrations show that the resulting hoop stress is about 1.15, 1.0, 0.9 times the longitudinal stress. In the first row of FIG. 4 (with R/t=50, L/R=3, Ē_{f}/Ēₛ=30), the resulted buckle morphology becomes herringbone, square, and latitudinal, respectively, except near the edges due to the boundary effect. These new 3D profiles can find potential applications in microfabrication, and they can also shed some light to some natural and biological arrangements. For example, the latitudinal pattern is somewhat like that observed on an elephant's tail or a Shar-Pei's skin, indicating possible anisotropic local skin growth of the elephant or dog.

In practice, the anisotropic film stiffness can be easier to achieve or control than anisotropic growth or shrinking. Consider an orthotropic film, whose Young's modulus is E₁ and E₂ along the local material axes 1 and 2, is bonded to an elastic and isotropic cylindrical substrate as shown in the inset of FIG. 4. In general, the angle between the local film material axis and the global substrate hoop (θ) direction, α, can be nonzero. In terms of the spontaneous buckle pattern and representative examples given in the second row of FIG. 4, the anisotropic effect couples strongly with the curvature effect. For example, the buckles do not align with the material anisotropy direction (unless the substrate is completely flat), and the difference between the inclination angle of formed buckles (β) and the material anisotropy angle (α) increases nonlinearly with the substrate curvature (t/R). Moreover, α−β is also largely affected by the boundary (edge) effect, and such a difference is larger when L/R is smaller. In essence, β depends on α, R/t, and aspect ratio L/R, as well as the ratio between the two orthotropic moduli, m=E₂/E₁. If the substrate radius of curvature is relatively large (R/t>50) and the edge effect is relatively small (L/R>4), then β becomes close to the direction of the minimum bending stiffness of the orthotropic plate.

The critical buckling wavelength (i.e., the normal spacing between neighboring inclined teeth of the gear-like profile, along the ξ-direction), on the other hand, is insensitive to L/R. Along the buckled direction (ξ), the effective modulus E_{ξ} can be obtained via transformation of the stiffness matrix of the orthotropic film, which is a function of α, β, and orthotropic elastic constants. Based on other demonstrations, the critical buckling wavelength \hat{λ}_{cr}^{ξ} and critical buckling stress \hat{σ}_{cr}^{ξ} can be approximately derived as:

$${\hat{λ}}_{cr}^{ξ} = 2 π {t ( \frac{R}{t} )}^{\frac{1}{4}} {( \frac{{E}_{β}}{12 {\tilde{E}}_{s} cos β} )}^{\frac{1}{4}} and {\hat{σ}}_{cr}^{ξ} = {( \frac{{E}_{β} {\tilde{E}}_{s} cos β}{3} )}^{\frac{1}{2}} {( \frac{t}{R} )}^{\frac{1}{2}} \qquad ( 7 )$$

Note that the form is similar to that in Eq. (5). Moreover, the expression of the buckle amplitude is identical to that in Eq. (6). Despite these similarities, we remark that in Eq. (7) β is also a nonlinear function of R/t; in other words, the effects of substrate curvature on the buckling characteristics (including the critical stress, wavelength and amplitude) are much more complicated in the case of anisotropic thin film.

The illustrated profiles in FIG. 4 are illustrative examples of true 3D patterns and microstructures that are otherwise difficult to make using conventional techniques such as photolithography (the high aspect ratio gear in FIG. 3 is another such example). It is demonstrated that mechanical self-assembly of buckles on curved substrates can provide an alternative approach to fabricate ordered 3D microstructures in a quick, simple, and cost-effective way.

Some embodiments illustrate thick shell and global instability of coiling of long cylindrical shell/core arrangements. When the thickness of a film (or shell) is much smaller than that of the underlying compliant substrate (or core), i.e., t<<R, upon bifurcation, the strain energy is mainly released through the wrinkled film surface morphology (as described above). However, when the thickness of the shell is comparable to that of the cylindrical core, under mismatched axial deformation, a global instability mode can occur in long cylindrical shell/core arrangements, forming spring or coil-like structures via global bending and/or twisting.

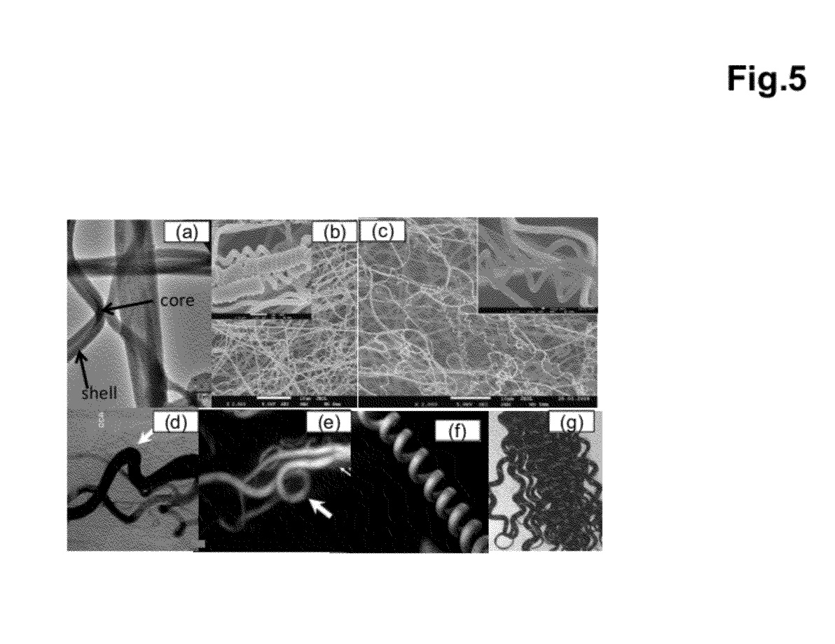

Through coaxial electrospinning, nanofibers with stiff shell and soft core structures have been produced (FIG. 5a). Upon differential shrinkage between the shell and core, the axial compressive stress developed in the shell can trigger global buckling and form nanosprings or nanocoils, FIGS. 5b and 5c. When the core radius is comparable to the shell thickness (e.g., t/R=0.5 and 0.34), significant nanospring formation can be observed. Nanocoils can be formed with relatively large core size (e.g., t/R=0.21). In addition, the nanospring structure is also observed in soft shell/stiff core arrangements, indicating comparable contributions of the strain energies in the shell and core.

Coiling is also often observed in helices, DNA, arteries, hair, and plant tendrils, etc. Arteries are subjected to significant mechanical load from the blood pressure and the longitudinal tension arising from surrounding tissue. An artery can be regarded approximately as a long circular cylinder comprised of an external thick wall and a fluidic core. Under certain combined loads, mechanical buckling of arterial vessels can occur which can lead to arterial tortuosity or kinking (FIG. 5d), which can be associated with significant clinical complications. Global buckling instability mode can show the significant effect of longitudinal strain (which can be caused by reduced axial tension or other clinical observations) on the bending and buckling of arteries. In addition to the bending deformation in kinking, arterial coiling can also occur with twisting deformation, which can be observed on human internal carotid arteries (FIG. 5e). Understanding of the global instability mode can once again shed light on the role of stress on the formation of kinking and coiling in arteries, plant tendrils (FIG. 5f), human/animal hair (FIG. 5g), and many others.

Some embodiments include spherical substrates and illustrate the effect of sphere curvature on critical buckling stress and wavelength. Another geometry of curved substrate is spherical, which has a uniform curvature 1/R in all directions. Assuming the sphere surface is completely covered by an isotropic film, the same symbols to denote film and substrate properties are used. In such an arrangement with the increase of the mismatched strain between the film and substrate (Δε), the equi-biaxial stress in the film will build up. The magnitude of film stress in the pre-buckling state is

$${σ}_{f 0} = \frac{{EE}_{s} ( 3 {R}^{3} + 3 {R}^{2} t + {t}^{3} ) Δɛ}{\begin{matrix}3 {E}_{s} {R}^{3} ( 1 - v ) + {E}_{s} ( 1 + v ) ( 3 {R}^{2} t + 3 {Rt}^{2} + {t}^{3} ) + \\ 2 E ( 1 - 2 {v}_{s} ) t ( 3 {R}^{2} + 3 Rt + {t}^{2} )\end{matrix}} \qquad ( 8 )$$

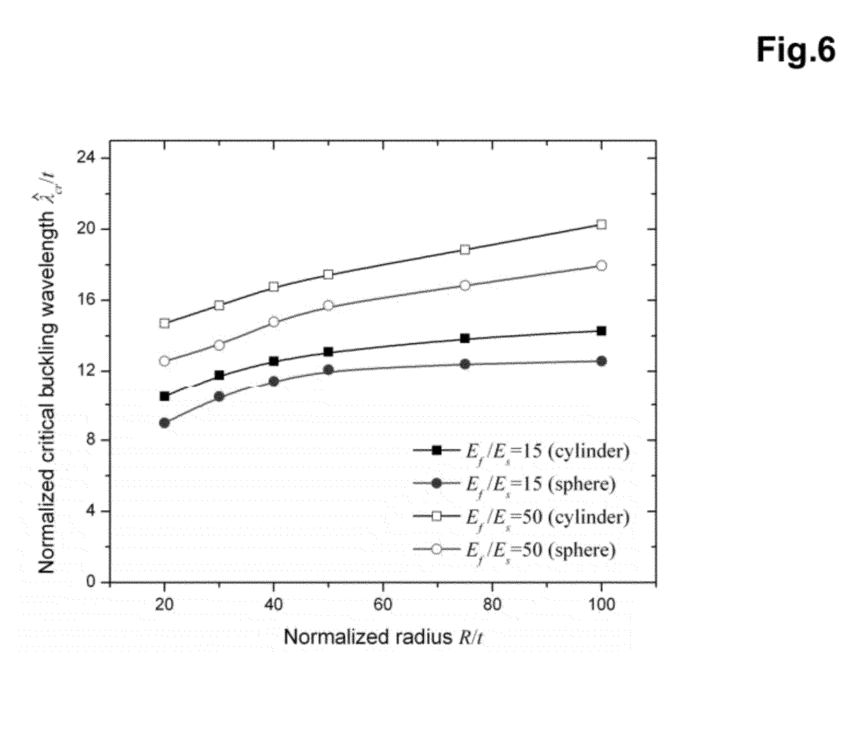

When compared with the cylindrical counterpart in FIG. 1, it can be seen that for a spherical substrate, the film stress varies slightly slower as R/t is changed. If the film stress (or equivalently Δε) is within a moderate range above critical, as long as E_{f}/Eₛ is not too small and R/t is not too large, for a wide range of material and geometrical parameters, the buckled patterns persist in distinct prolate arrangements. Other trends are close to the case of the cylindrical substrate. Note that Eq. (8) is valid for any film thickness. For thin films, the higher-order terms are negligible. When σ_{f0} exceeds a critical value, the film will buckle. Because the stress is isotropic and uniform, there is no preferential orientation of the buckles. When the elastic mismatch between the film and substrate is fixed, reticular and labyrinth wrinkle patterns emerge at small and large R/t, respectively (and can be widespread over the entire surface of the film). With increased mismatch strain, the reticular pattern can transit to a labyrinth one. FIG. 6 compares the normalized buckling wavelength between spherical and cylindrical substrates (computed from FEM demonstrations). The normalized buckling wavelength as a function of the substrate radius of curvature. Different film/substrate stiffness mismatch ratios are shown. For both substrates, the normalized wavelength increases nonlinearly with the dimensionless substrate radius R/t and stiffness mismatch E_{f}/Eₛ. However, the wavelength in the spherical substrate is slightly lower than that in the cylindrical one when the two arrangements have the same curvature and modulus ratio.

The mechanical principles reveal that the substrate curvature t/R, elastic modulus mismatch E_{f}/Eₛ, and mismatched strain Δε, are the governing parameters of buckling patterns. A labyrinth pattern emerges when R/t is relatively large, E_{f}/Eₛ is relatively small, or Δε is relatively large. The curvature effect is coupled with the other two effects. For a spherical substrate, the buckling wavelength can be enhanced by increasing E_{f}/Eₛ or R/t. The critical buckling threshold can be reduced by increasing R/t or decreasing E_{f}/Eₛ, and the larger buckling amplitude can be obtained by increasing Δε.

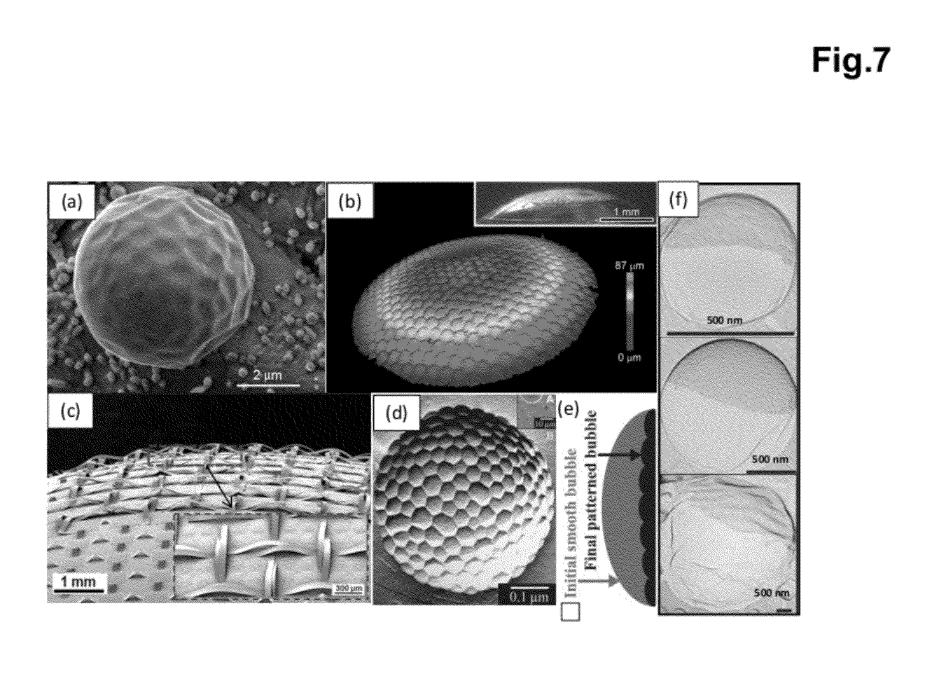

Spontaneous buckling pattern formation on spherical substrates has been demonstrated. Using co-evaporation technique, a thin SiO₂ film with thickness of about t=150 nm was bonded to a nearly spherical Ag substrate at high temperature. The substrate radius varied from R=1 to 50 μm. When the arrangement was cooled, owing to the thermal strain mismatch, the SiO₂ film buckled, and the shape, wavelength, and critical stress conformed well to the mechanics principles. FIG. 7a shows an example with R=3 μm. At this relatively small R/t, a reticular pattern was produced via spontaneous buckling. This is another example of buckling self-assembly fabrication of true 3D structures at micro or submicron scales.

Among other demonstrations of fabricating 3D micro/nanopatterns and microstructures on curved substrates, surface wrinkles in small local pre-patterned regions have been confined. When such a technique was applied to a hemispherical surface, microlens arrays were self-assembled (FIG. 7b). Interconnected silicon ribbon-like photodetectors on a hemispherical elastomer substrate have been assembled. The ribbons were in buckled profiles, owing to pre-stretch (FIG. 7c). It should be noted that in these demonstrations, the buckle features created were much smaller than the substrate radius of curvature; in other words, the versatile effect and potential of substrate curvature were not fully utilized to regulate the self-assembled buckles.

Besides the aforementioned solid arrangements, buckling self-assembly was also demonstrated on fluidic spherical shell/hollow core microstructures, i.e., microbubbles. In a recent illustration on the nanopatterning of stable microbubbles, a nano scale hexagonal interface pattern has been created as shown in FIG. 7d through the shrinkage of the bubbles. By covering a surfactant layer on the surface of microbubbles, due to the differential shrinkage, the initial smooth bubble buckled into a nanohexagonal patterned one (FIG. 7e). FIG. 7f further demonstrates the important effect of curvature on the surface wrinkling pattern, as the bubble radius was varied from 500 nm to 3 mm. Note that besides mechanical buckling, phase separation and other surface mechanisms can also underpin the pattern domains in microbubbles, and various pattern formations have been reported, including polygons, dendrites, beans, and networks, etc.

It is illustrated that by coupling the intriguing substrate curvature effect with local inhomogeneous or controlled mismatch deformation, more varieties of buckling patterns that underpin micro or nanopatterns and structures can be spontaneously fabricated on curved substrates, thereby extending the scope of the presently described subject matter.

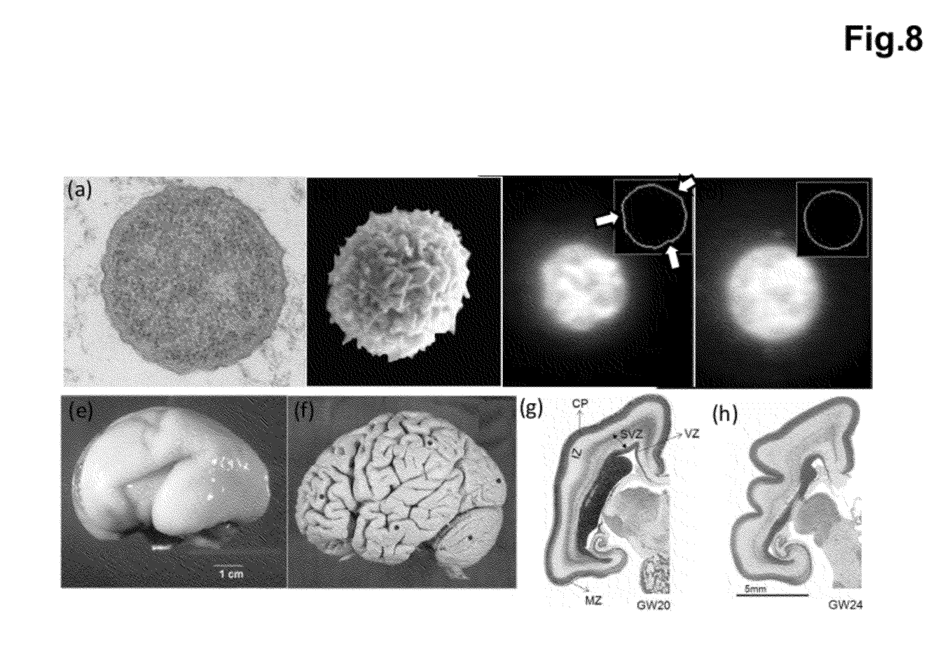

Under certain conditions, a cell with an initial smooth surface morphology can become wrinkled, which is often observed in bacterial cells (FIG. 8a where the average wrinkle wavelength is about 100 nm) and non-tissue cells such as human neutrophil cells (FIG. 8b), macrophages, lymphocytes, and mast cells. The wrinkled morphology can increase the surface area of the cell by more than 100%, which can accommodate potential membrane expansion and spreading during extravasation and osmotic swelling. From a mechanics point of view, it has been argued that cell wrinkling can be regarded as a buckling instability behavior induced by the mismatched deformation between the cell membrane and the cytoplasm. Such a mismatched deformation can arise from the relative shrinkage of the cytoplasm under hyperosmotic pressure (e.g., that in FIG. 8a) or the relative expansion of the cell membrane surface area during cell growth or phagocytosis (e.g., that in FIG. 8b).

Other than the cell membrane surface wrinkles, recently similar wrinkled morphology was observed inside the cell, e.g., on the cell nucleus due to hyper-osmotic shrinkage, FIG. 8c. The nucleus wrinkles can be explained by the mechanical buckling of the shell/core structure, where the contraction of the soft core (nucleoplasm) renders the stiffer shell (nuclear lamina) in compression to initiate the buckles. Under hypo-osmotic pressure, the swelling of nucleoplasm will make the lamina in tension and stretch the lamina into a smooth shape as shown in FIG. 8d.

Besides the cellular scale, the wrinkled morphology is also frequently observed at larger tissue or organ scales. An example of the wrinkled brain cortex is shown in FIG. 8f. The human brain cortex is not born with wrinkles and folds; in the fetus period it is smooth (see FIG. 8e). As the neurons continue to divide, grow, and migrate, the cortex folds and forms a recognizable yet unique pattern of bumps and grooves. The cross-section of the hemispherical cortex reveals the detailed information on the formation of the gyri (ridge) and sulci (groove) during development. FIG. 8g shows a relatively smooth cross-section of the cerebral cortex at gestational week (GW), where the multilayer architecture of the cerebral cortex is demonstrated, which consists of the superficial marginal zone (MZ), cortical plate (CP), intermediate zone (IZ), subventricular zone (SVZ), and ventricular zone (VZ) from exterior to interior. At GW, the wrinkled morphology is observed (FIG. 8h).

Understanding of the folding pattern of the brain cortex has important implications in medical science, since that is closely associated with intelligence and some brain diseases, including schizophrenia and autism. Neurological disorders such as Williams syndrome and lissencephaly can result in abnormal cortical folding, where the folding wavelength increases and the amplitude of wrinkles becomes smaller. The reduced cortical folding in mental retardation (MR), has been demonstrated where significantly reduced gyrification was observed in multiple brain regions compared with healthy counterparts, which was possibly attributed to the abnormalities in the subcortical structure.

Models to explain how and why the cortex folds in a characteristic pattern from the biological, biochemical, and mechanical viewpoints have been set forth. The first is a mechanical buckling model where the cerebral cortex was modeled as a bilayer shell rested on a soft spherical core. The excessive growth of the shell relative to that of the core leads to the development of compressive stress in the shell, and the subsequent buckling can lead to the cortical folding.

The extension of the fundamental model in the described subject matter, with the incorporation of the more realistic multilayer structure, anisotropy and heterogeneity, and growth behavior of the cerebral cortex tissues, can explain some factors affecting the fold pattern and fold number in the cerebral cortex and provide useful techniques for understanding several brain diseases.

The overall geometry of some cells and the brain cortex might not be spherical. They can be better modeled as spheroids. The spontaneous buckling pattern formation on spheroidal substrates is discussed below.

Some embodiments illustrate spheroidal substrates and the buckling patterns and governing parameters thereof. Owing to the isotropic and homogeneous film stress field, an ideal spherical substrate can lead to two types of patterns (reticular or labyrinth), yet a simple variation of the substrate geometry to a spheroidal geometry can render more variety of 3D self-assembled buckling profiles (driven by anisotropic and inhomogeneous film stress field), which can also be bridged with the morphogenesis of quite a few natural and biological arrangements elucidated below.

Consider a model spheroidal substrate (x²+y²)/R²+z²/b²=1 in Cartesian coordinates, which is completely covered by (and remains bonded to) a thin film of thickness t. Two dimensionless factors can effectively characterize the normalized substrate radius of curvature: the normalized equator radius R/t and the aspect ratio k=b/R. If the relatively minor influence of the Poisson's ratio is neglected, then the buckling characteristics will additionally depend on the elastic mismatch between film and substrate, Ē_{f}/Ēₛ, and the mismatch strain between them, Δε. The effects of these four governing parameters on the buckling morphology are given below.

In the pre-buckling state, owing to the inhomogeneous curvature of the spheroidal arrangement, upon mismatched deformation between film and substrate, the pre-buckling stress in the film is nonuniform (inhomogeneous) and anisotropic. In a prolate spheroidal arrangement (k<1.0), for example, the hoop stress at the equator (z=0) is the most prominent component. Thus when the arrangement is just above critical, longitudinal ridge-like buckles first appear near the equator. For an oblate spheroid (k<1.0), circumferential undulations first occur around the polar region to release the most prominent local longitudinal stress.

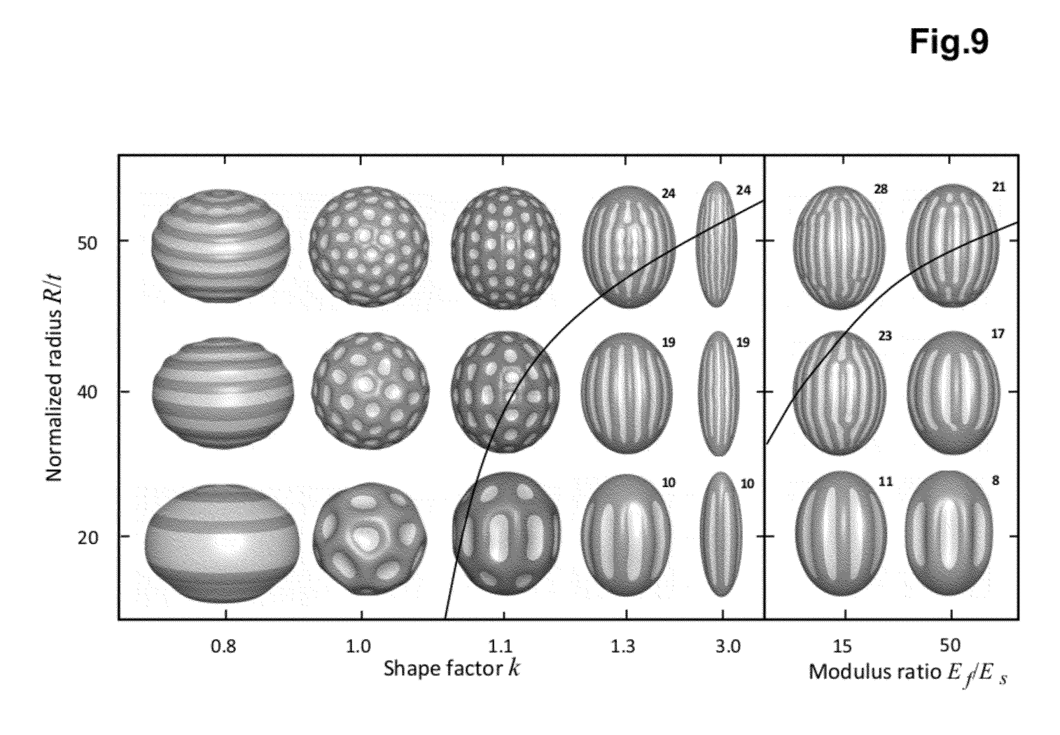

With the increase of Δε, the ridged pattern in prolate extends to the poles and the circumferential pattern in oblate extends to the equator. If Δε becomes sufficiently high, however, labyrinth patterns can become a more effective way of relieving strain energies, especially in those structures with large R/t and those with k closer to 1.0. In this case the labyrinth pattern will become widespread over the surface (somewhat similar to the brain cortex). In what follows, the effect of R/t and how it interacts with that of k and Ē_{f}/Ēₛ is illustrated. The initial bifurcation mode at low Δε just above critical can be useful in view of the fact that large stress can not be preferred in biological arrangements nor fabrication. If the film stress (or equivalently Δε) is within a moderate range above critical, as long as E_{f}/Eₛ is not too small and R/t is not too large, for a wide range of material and geometrical parameters, the buckled patterns persist in distinct prolate arrangements. The results obtained from FEM illustrations are summarized in FIG. 9.

In FIG. 9, the left: R/t vs. k with Ē_{f}/Ēₛ=30. In the right: R/t vs. Ē_{f}/Ēₛ with k=1.3. The bright color shows the concave “bottom” of buckles. The number of longitudinal ridges is shown on the top corner of each relevant pattern. It is reminded that here R is the equator radius and thus consistent with other geometrical profiles of curved substrate discussed in the described subject matter, whereas, in previous work, R had a different meaning and it represented the radius of curvature at the north pole.

In a distinct prolate arrangement, when the substrate is relatively small with low value of R/t, the ridged pattern prevails, and the wave number of ribs increases rapidly with R/t. Meanwhile, when R/t is large, the formation of circumferential waves is possible. Thus the reticular buckles can appear almost uniformly on the surface (especially when k is small, close to the case of spherical substrate). The interaction between R/t and Ē_{f}/Ēₛ further shows that at small Ē_{f}/Ēₛ and large R/t, a reticular pattern can be advantageous over ribbed one, and with the increase of modulus mismatch, the number of ribs in the undulated film decreases. When the substrate curvature is relatively large (R/t<40), the ribbed patterns can remain stable for a large range of modulus ratio (5≦Ē_{f}/Ēₛ≦200) although the rib number can vary.

Quantitatively, for distinct prolates, the ridge number is a function of R/t and Ē_{f}/Ēₛ, which is described by Eq. (5). Similarly, Eq. (6) can be used to predict the buckle amplitude of prolate arrangements. Although these two equations should, in principle, be applied to cases where k approaches infinity, extensive analyses show that the principles can be applied where k>1.3. Therefore, controlling the buckle wave number and amplitude for distinct prolate film-substrate arrangements can be similar to those described above, which underpin the application below.

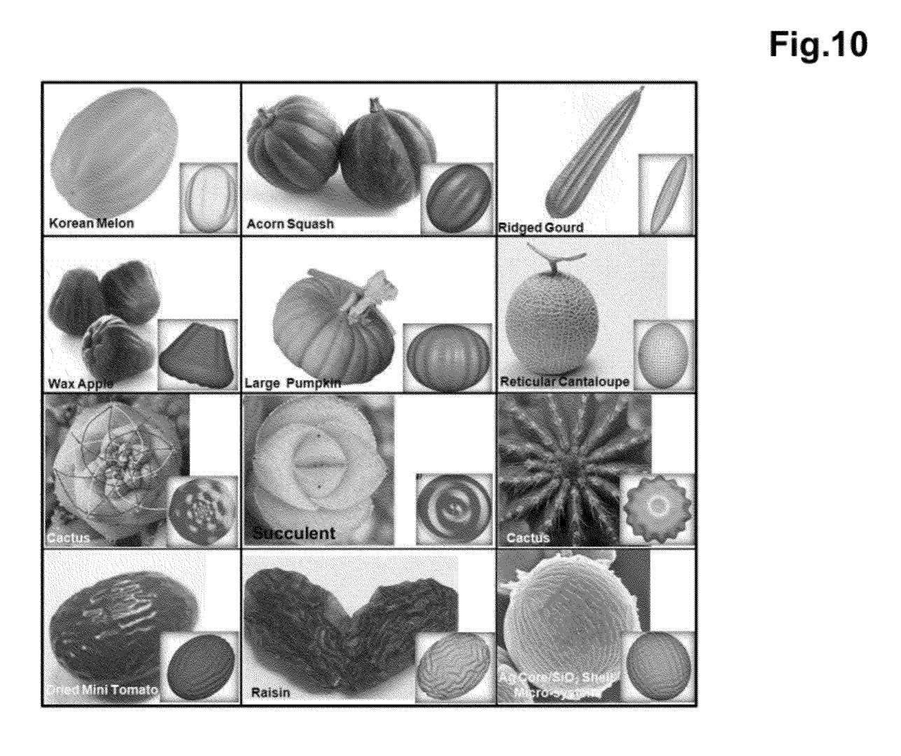

Many fruits, including varieties of cucumis melons, gourds, tomatoes, peppers and pumpkins, take approximate spheroidal shapes with stiff skin (film/shell) bonded to compliant flesh (substrate/core) and exhibit distinctive wrinkle-like undulation morphologies (FIG. 10).

In FIG. 10, the first row and second row illustrate the morphologies of several fruits and vegetables, including Korean melon, acorn squash, ridged gourd, wax apple, large pumpkin, and cantaloupe, which can be reproduced via the spheroidal shell/core model. The third row illustrates plant phyllotaxis including cactus and succulent (1^{st} and 2^{nd} cases), which can be explained using instability theory. The model of spheroidal elastic shell/foundation model can also explain the ridged pattern in cactus (3^{rd} case). In the Last row, the same principles are applicable to dehydrated fruits such as dried mini tomatoes and raisins, as well as in 3D self-assembly applications using SiO₂ film/Ag substrates.

For example, the Korean melon and ridged gourd are distinguishable by 10 equidistant longitudinal ridges. Small pumpkins, acorn squashes, and carnival squashes often have about 10 uniformly spaced ribs, whereas the large pumpkins often have about 20 or more ridges. Cantaloupes exhibit reticular patterns on their surfaces. More complicated and intriguing phyllotactic patterns are often observed in plant shoots, flowers, and the cactus head. Such distinctive yet elementary global (overall) features can be contributed in part by the stress-driven spontaneous buckling (due to the mismatched growth between the stiff skin and compliant flesh), whose bifurcation mode can set up the template for parallel biological processes.

Using the simple spheroidal shell/core model, various global appearances of a number of fruits and vegetables can be reproduced. Several examples obtained from FEM demonstrations are shown in the first two rows in FIG. 10, where a distinct morphology emerges when the governing parameters (k, R/t, Ē_{f}/Ēₛ) are within a particular range. Moreover, the stable ribbed patterns are insensitive to minor perturbations, such as the inclusion of a rigid or compliant core, or boundary constraints at the poles. Major perturbations, including the variation of the substrate curvature, anisotropic growth rate or elastic properties, do affect the buckling pattern considerably, which is similar to that which was described earlier. The same principles can be easily extended to those observed on eggs, dehydrated fruits (last row of FIG. 10), cells, tissues, etc. Some have been discussed earlier for spherical substrates and extendable to spheroidal arrangements.

Besides these global morphologies, the local phyllotaxis on plant surfaces can also be due to similar buckling instability. A wide spectrum of plant patterns observed in nature have been reproduced. Two examples of cacti and succulents are given in the third row of FIG. 10. The cactus can also be modeled as a thin spheroidal elastic shell rested on an elastic foundation. Such a model can explain the configuration transition between the whorl pattern and the ridged pattern observed in cactus (third image in the third row of FIG. 10).

Regarding engineering applications, for the same 3D fabrication demonstration described above, when the inorganic substrate is spheroidal-like, the last image of FIG. 10 shows the SEM photo of the rib-dominated buckled patterns observed in a prolate arrangement (Ag core/SiO₂ shell), where k=1.15, R/t≈55, and Ē_{f}/Ēₛ≈5, respectively. In all examples demonstrated in this section, the profiles obtained from numerical demonstration, the buckling shape and wavelength predicted from equations (e.g., Eqs. (5) and (6)) and the practical observations agree well with each other.

Some embodiments include combined cylindrical and spherical substrates. Many mechanics illustrations on skin wrinkles have been confined to planar substrates. There has been little emphasis on the potential influence of the underlying substrate tissue curvature. A common phenomenon that everybody has experienced, the wrinkles appearing on a human fingertip upon water immersion, illustrates the role of substrate curvature and further bridges the buckling mechanism with the morphology of biological components. From recent advances in physiological demonstrations, the driving force behind fingertip skin wrinkle is vasoconstriction of the underlying tissue, which decreases the turgor and effectively shrinks the tissue volume to produce compressive stress in the skin.

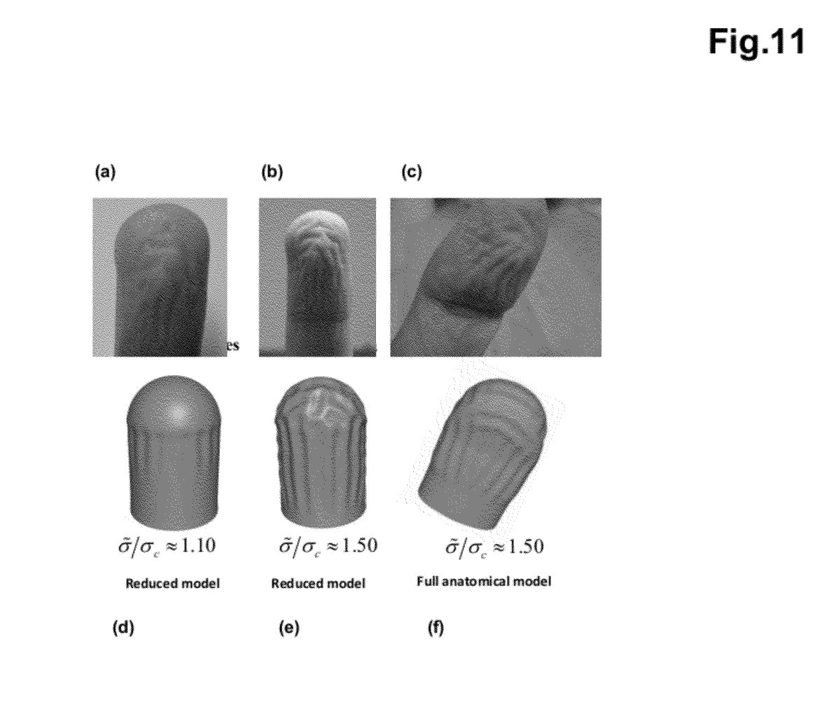

As a first order approximation, the substrate of a fingertip can be regarded as roughly a half cylinder topped with a hemisphere (the flat surface on the backside corresponds to the “nail” 20 region that does not wrinkle). A typical radius of the substrate is R=7.5 mm and skin thickness is t=0.15 mm. When the compressive stress in the film is just above critical, longitudinal wrinkles first appear near the conjunction of the cylindrical and spherical parts (which corresponds to the center of the finger pad). With continued increase of Δε (i.e., with prolonged water immersion time), the longitudinal wrinkles propagate along the cylindrical pad, whereas reticular concaves are observed on the spherical finger tip. When Δε is relatively large, the labyrinth pattern takes over on the finger pad, FIG. 11.

In FIG. 11, the first row includes an exemplary wrinkled morphology of fingertips with immersed times of 5 minutes (a), and 30 minutes (b, c). The second row includes demonstrations from the corresponding reduced model (d, e), and the full anatomical model (f) with qualitative agreement.

The wrinkle amplitude increases nonlinearly with Δε whereas the wavelength remains almost a constant. Owing to the boundary constraint, along the circumferential direction, the wrinkle amplitude is the largest at the center of the finger pad and decays away near the nail region. Since the wrinkles in the cylindrical section are more prominent, the mechanical principles developed in above apply well. For example, if the substrate curvature is increased (while other parameters remain fixed, e.g., from thumb to little finger), the wrinkle wavelength and amplitude decreases and wrinkling becomes less pronounced. These features are qualitatively consistent with practical observations.

The substrate geometry can be further refined based on the anatomical structure of the human fingertip. Moreover, in order to realistically capture the skin behavior, the multilayer structure of the skin and tissue can be taken into account, which includes the stratum corneum, viable epidermis, dermis, subcutaneous, and bone. The example shown in FIG. 11c reveals similar features as the demonstrations using the simplified model (FIGS. 11a and 11b). A parametric illustration can be used to explore the role of each individual layer on wrinkling characteristics. These examples can provide useful techniques on skin aging and suppressing wrinkles and can be useful for biomedical and cosmetic science.

Some embodiments illustrate elastic buckling of gradient thin films on compliant substrates

Self-assembled buckling morphology of thin films on compliant substrates (caused by mismatched deformation) is described with broad potential applications in stretchable electronics, fabrication of 3D micro/nanostructures, measurement of material properties, and morphogenesis of some natural and biological arrangements, among others.

Most previous demonstrations have been limited to thin films with uniform thickness and homogeneous mechanical properties (termed as uniform films hereafter). If the film thickness t is a constant, when the film is subjected to either uni-axial or equi-biaxial compressive stress σ and the film buckles elastically, the buckling wavelength λₒ, the critical buckling stress σ_{co}, and the amplitude Aₒ of the uniform film can satisfy the scaling laws:

λ₀∝t(E/E_{S})^{1/3},σ_{c0}∝(Eₛ²E)^{1/3},Aₒ∝t(σ/σ_{c0}−1)^{1/2} (9)

where E and Eₛ are Young's moduli of the film and substrate, respectively. In a uniform film with given properties/thickness, the resulting buckling morphology is also “uniform” in terms of the constant wavelength and amplitude (i.e., spatially invariant).

With the wide application of functional gradient materials, if a gradient film is employed, the resulting buckling wavelength and amplitude are no longer spatially uniform, which can lead to a variety of new morphological patterns of self-assembled buckles. Since the adhesion and superhydrophobic properties are dependent on the surface wrinkle wavelength, a buckled gradient film with continuously varying surface profiles/properties can be applied in cell adhesion and micro-fluidic channels.

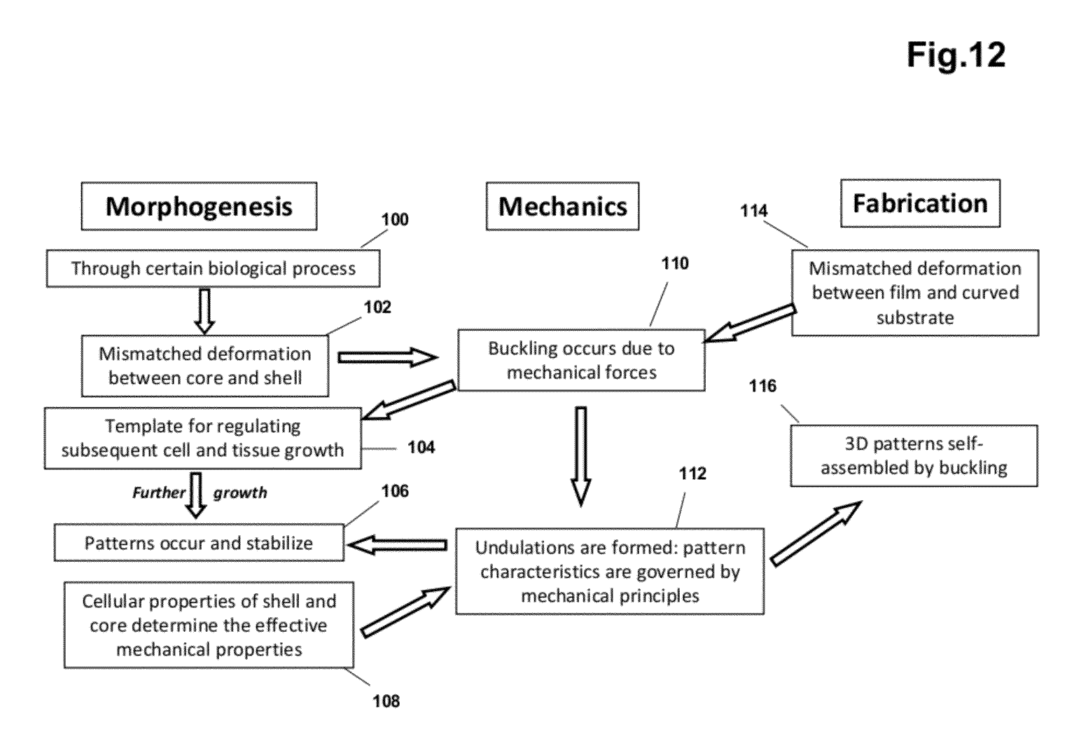

For FIG. 12, for mechanics vs. morphogenesis, due to certain biological processes occurring at the cellular level (100) in some arrangements, the film and substrate undergo mismatched deformation (102), and the resulting stress-driven buckling (110) sets up a template for the overall arrangement morphology (104). The processes of cell growth and cell differentiation (104) can follow the mechanical template (112) to help stabilize the global pattern features (106). On the other hand, the bifurcation mode is also closely related to the effective material and geometrical properties (108) (which are based on biological processes). For mechanics vs. fabrication, mismatch deformation between film and substrate (114) leads to mechanical buckling (110). Undulations are formed, governed by mechanical principals (112), which further underpins the novel technique of self-assembly fabrication of 3D microstructures (116), which is inherently simple, quick, and cost-effective.

An exemplary mechanism of a gradient thin film on a compliant substrate is described, which can shed some light on manipulating and controlling “nonuniform” surface morphology and properties.

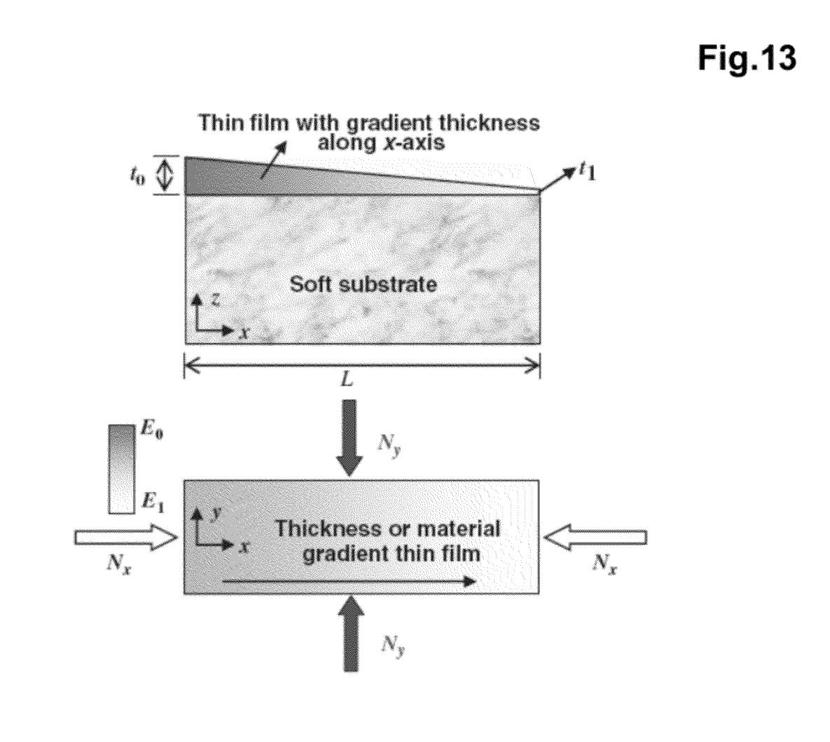

In FIG. 13, the gradient is along the x-direction. The film is under uniaxial compression, whose direction can be either parallel (Nx) or perpendicular (Ny) to the gradient direction.

With regard to the schematic in FIG. 13, for simplicity, it is assume that the thickness or material property varies in one direction, for example, in the x direction. The film thickness t(x) or Young's modulus E(x) varies linearly according to

t(x)=t₀(1−αₗx/L) or E(x)=E₀(1−α_{E}x/L) (10)

where L is the film length along the x axis, t₀ and E₀ are the reference thickness and reference modulus at x=0, respectively, t₁ and E₁ are the thickness and modulus at x=L, respectively, αₜ and α_{E} are the gradient coefficients defined as αₜ=(t₀−t₁)/t₀ and, α_{E}=(E₀−E₁)/E₀ (t₀>t₁, E₀>Eₗ), respectively, with 0≦αₜ, α_{E}<1.

The gradient slopes, αₜ/L and α_{E}/L, also indicate how “quickly” the film thickness and modulus vary in the x-direction.

First, attention is directed to uniaxial film compression. According to FIG. 13, the uniaxial load can be aligned either perpendicular to the gradient direction (where an applied force N_{y} would cause branching waves, see below) or along the x-axis (where an applied force Nₓ would cause “plane strain” buckles parallel to the y-direction). These two loading scenarios are illustrated below.

For each loading scenario, the characteristics of film gradients (αₜ or α_{E}) are varied in a moderate large range to illustrate the effect of film thickness or modulus gradient. For a given film/substrate arrangement, the demonstration starts with numerical demonstrations based on the finite element method (FEM). In these demonstrations, t₀˜55 nm and E₀=80 GPa are kept fixed, and Young's modulus of the semi-finite compliant substrate is Eₛ=20 MPa. Three dimensional finite element demonstrations can capture the detail of the global buckling patterns. The film and substrate remain bonded in the due course of buckling. During the demonstration of the thickness gradient effect, the modulus gradient is kept at zero and vice versa. Based on the information obtained from FEM demonstrations, simplified analytical efforts are used to better illustrate the general effects of film gradients on buckling characteristics (including the critical buckling load and shape factors of the buckled morphology).

The buckling of a thin polystyrene (PS) film on a thick PDMS substrate has recently been demonstrated. When loading is normal to its thickness gradient direction. It has been shown that the local buckling wavelength λ increased linearly with the local PS thickness t, and the doubling of the local film thickness results in a doubling of the local buckling wavelength. The results indicate that, despite the thickness gradient, the extension of Equation (9), E∝Eₛ(λ/t)³, is sufficient and such a buckling-based metrology can effectively measure the modulus E of polymeric thin films. Note that in the demonstrations, αₜ=0.5 yet L is larger than 1 mm, which is much larger than the nanoscale film thickness. In other words, the film thickness varies slowly along the x-direction, and the gradient slope αₜ/L is very small. Under this circumstance, Equation (9), which is based on uniform film, remains effective to the gradient film, i.e.

λ(x)∝t(x)(E/Eₛ)^{1/3} (11)

However, if the gradient slope is relatively large, such an extension of Equation (9) cannot be very accurate—this is examined using FEM demonstration as follows.

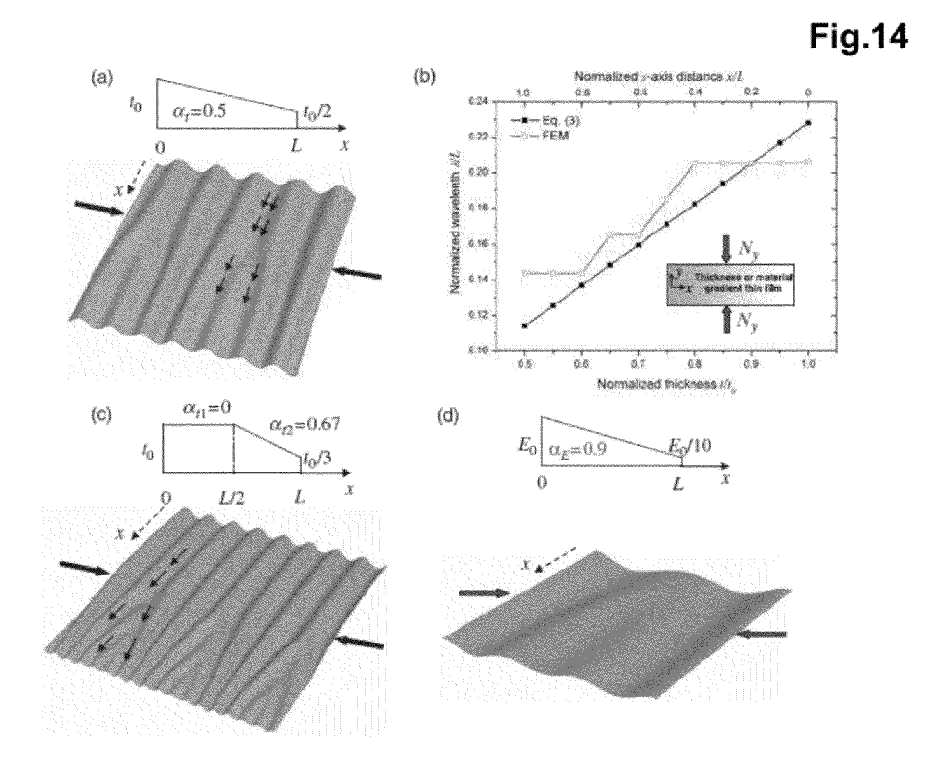

FIG. 14a shows the illustrated global buckling pattern of a thickness gradient film with the same aₜ=0.5 (i.e., t₀=2t₁, and there is no modulus gradient) and with a small film length L=16 μm (the substrate is not shown for clarity). Different from the uniform wavy buckling patterns with a constant film thickness, FIG. 14a demonstrates a Y-branched morphology with varied wavelength. Qualitatively speaking, a larger local thickness results in a relatively larger local buckling wavelength λ. As the film thickness reduces in x-direction, the buckles transit from waves of larger λ to those with smaller λ, forming the branched morphology.

From the demonstration result in FIG. 14a, the quantitative relationship between λ and t can be measured and presented in FIG. 14b. In this case, where the gradient slope αₜ/L is relatively large, λ varies in a step-like manner with respect to t, as opposed to the linear variation shown by Equation (11). Owing to the edge effect (which is not incorporated in the derivation of Equation (11)), the buckling wavelength is almost a constant near the edge of the FEM demonstration. Near one edge x/L=0, where the average thickness is smaller than t₀, the resulting wavelength is smaller than that of the uniform film with thickness t₀. Similarly, near the other edge x/L=1.0, the average thickness is larger than t1. This is consistent with the local wavelength, which is larger than that of a uniform film with thickness t₁. Overall, the step-like variation of λ leads to the branched buckles. Also note that the shear stress at the film/substrate interface can become significant near the transition areas of the junctions/branches. Overall, despite the large gradient slope, the buckling wavelength shown by Equation (11) is relatively close to that deduced from demonstrations, as illustrated in FIG. 14b, which shows that the simple Equation (11) is still reasonably effective.

To further illustrate the effect of the thickness gradient on the buckling pattern, consider another example in FIG. 14c where the top half of the film has a constant thickness, whereas the bottom half of the film has a thickness gradient aₜ=0.67 (over a length L/2). FEM demonstration result shows that when the gradient slope is very large (here the gradient slope in the lower half of FIG. 14c is three times larger than that in FIG. 14a), a multi-branched buckling morphology can be formed, owing to the rapid transition of λ. In the upper half, the uniform thickness leads to uniform waves, which are connected smoothly to the two-junction non-uniform channels in the lower half. FIG. 14c also shows that the amplitude at the top is larger than that at the bottom with smaller thickness, which implies that the simple Equation (9) is still qualitatively effective for buckle amplitude. It is argued that through thickness variation design, a hierarchical multi-branched channel can be created when the gradient slope is large. By properly controlling the thickness gradients, these Y-branched or multi-branched geometry with various section characteristics can find potential applications in micro-fluidic channels.

Similar branched buckling patterns can also be produced in films with material stiffness gradient. Since Equation (11) predicts that compared with the effect of t, the effect of E is smaller on λ, thus, the effect of modulus gradient is illustrated by choosing a large value of a_{E}=0.9 (i.e., E₀=10E₁, with no thickness gradient). Despite the large material gradient slope, FIG. 14d contains a single small branched buckle, whereas FIG. 14a shows many branches in a specimen of the same size. In other words, the modulus gradient has a smaller effect on the buckling wavelength and the resulting buckling pattern. By following an analysis similar to that in FIG. 14b, it can be shown that λ(x)∝t(E(x)/Eₛ)^{1/3} roughly holds even for relatively large modulus gradient slopes.

In summary, when the load is perpendicular to the gradient direction, the local buckling wavelength and amplitude roughly conforms to the extension of the principle of a uniform film, λ(x)∝t(x)(E(x)/Eₛ)^{1/3}, which is valid for moderately large thickness gradient slopes and large modulus gradient slopes. Under the guidance of such a principle, sophisticated morphologies of micro-fluidic channels can be designed and controlled using different combinations of thickness and/or modulus gradients.

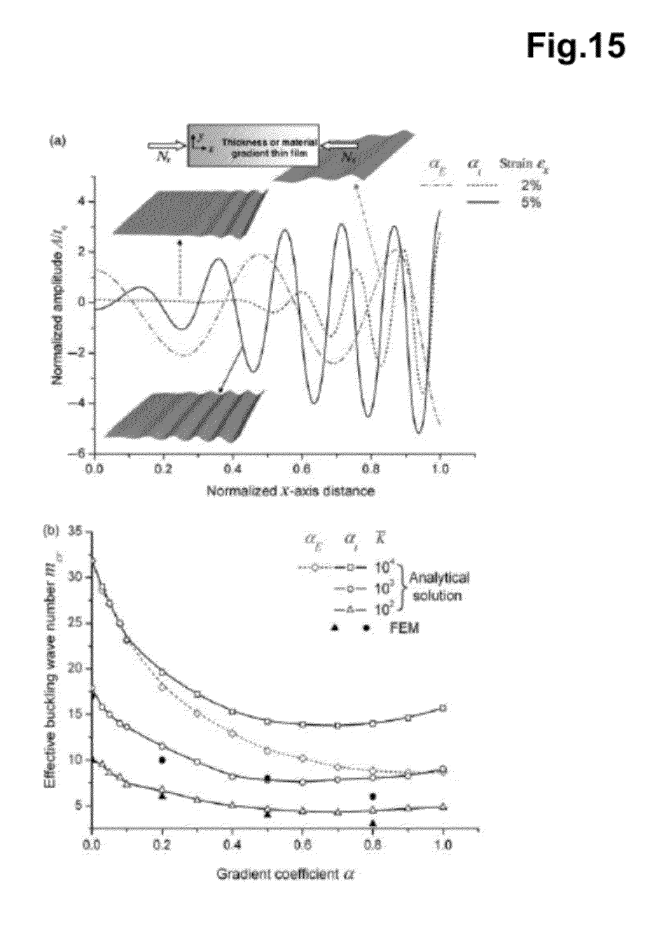

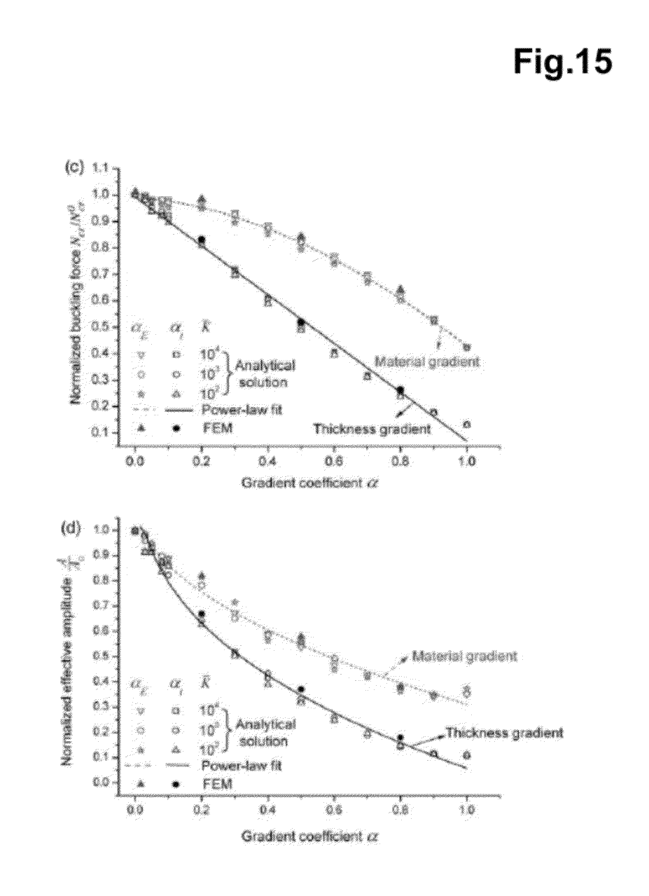

In other embodiments, when the compression is parallel to the gradient direction, distinct buckle patterns appear. Unlike the global buckle discussed above, as shown in FIG. 15a, with the increase of compressive strain, local buckles first occur at the thinnest (or most compliant) region at x=L, and the undulation gradually propagates to the thicker (or stiffer) region at x=0 to form “global” buckles. Such a trend is qualitatively consistent with the critical buckling force of uniform film, where bifurcation occurs more easily in a thinner or less stiff film (Equation (9)). If the gradient is smaller, the transition from local to global buckling is faster. In this case, the wavelength (in the x-direction) and amplitude are both nonuniform in the loading direction. FIG. 15a shows several examples of the buckled morphologies, for either thickness gradient aₗ=0.5 or material modulus gradient a_{E}=0.9. When global buckles are formed, in regions where the thickness is smaller or the film is more compliant, the wavelength is smaller. Yet the amplitude is higher. Although these trends are qualitatively consistent with that of uniform film, an illustration is used in order to reveal the quantitative gradient effect and to manipulate the buckle geometry more precisely.

If the deflection mode w₀(x) (displacement in the z-direction) can be specified, by minimizing the total potential energy of the plane strain film/substrate arrangement (which includes bending and stretching energies of the film and elastic energy stored in the substrate), the characteristic shape factors of the buckled profile and the critical buckling stress can be obtained. The shear stress at the film-substrate interface is ignored. The compliant substrate is simplified as an elastic Winkler foundation with an effective stiffness K. The total potential energy can be written as

$$Π = \frac{1}{2 L} {\int }_{0}^{L} D ( x ) {( {w}_{0} , xx )}^{2} d x - \frac{1}{2 L} {\int }_{0}^{L} {{N}_{x} ( {w}_{0} , x )}^{2} d x + \frac{1}{2 L} {\int }_{0}^{L} {Kw}_{0}^{2} d x \qquad ( 12 )$$

where the bending stiffness of the film is D(x)=D₀(1−αₜx/L)³ for thickness gradient, or D(x)=D₀(1−α_{E}x/L) for modulus gradient, with D₀=E₀t₀³/[12(1−v²)] and v the Poisson ratio of the film. ( ),ₓ=∂( )/∂x.

In principle, if the mathematical expression of the deflection mode w₀(x) is known, the boundary value problem of a semi-infinite domain can be solved to deduce the effective Winkler stiffness K (which depends on the buckling wavelength). While this approach is sufficient for the linear sinusoidal deflection mode in a uniform film, as shown in FIG. 15a, for a gradient film, the deflection mode incorporates the characteristic of increasing amplitude accompanying the decreasing wavelength along the x-direction, which is highly nonlinear. From the buckling profile obtained via FEM demonstration (FIG. 15a), the deflection mode of the gradient film can be fitted in the following nonlinear form:

W₀=A(1+απ x̅)sin(mπ x̅(1+απ x̅)) (13)

where x̅=x/L, and A and m can be regarded as the effective shape factors that qualitatively correspond to the effective amplitude and effective wave number, respectively. Although the real amplitude and wavelength are non-uniform (FIG. 15a), in order to clarify, the real buckling profile in FIG. 15a is fit into a “simpler” nonlinear equation, Equation (13), which enables the use of two effective parameters to approximate the shape of the buckled profile. In Equation (13), the term A(1+απ x̅) describes the increasing amplitude and sin(mπ x̅(1+απ x̅)) roughly depicts the varying nonuniform wavelength. a represents the gradient coefficient with either α=αₗ or α=α_{E} for the thickness or modulus gradient, respectively. When the gradient is zero, Equation (11) reduces to the classic sinusoidal mode w=A sin(mπx/L) for uniform film. In what follows, we will use these two effective shape factors, A and m, to characterize the deflection mode, and focus on the effect of the gradient coefficient on the shape factors.

Since the embodiments illustrate the effect of film thickness gradient or stiffness gradient on the buckling behaviors of the film, for simplicity and as a first step of illustration, a constant effective substrate Winkler stiffness K is assumed. With these assumptions, a numerical solution of the buckling of gradient film can be pursued. The effectiveness of such an approach can be validated by comparing with FEM demonstrations, elaborated below.

The minimization of Equation (12) with respect to A is performed numerically after the substitution of Equation (13), and the critical buckling force N_{cr} and the corresponding critical effective wave number m_{cr} can be obtained. The effective amplitude of the deflection, A, can be obtained from the inextensibility of the film during deformation, which satisfies

$${\int }_{0}^{L} \frac{N - {N}_{cr}}{E ( x ) t ( x )} d x = \frac{1}{2} {\int }_{0}^{L} {( {w}_{0 , x} )}^{2} d x \qquad ( 14 )$$

where N=Nₓ is the applied force at the buckled state. By substituting Equations (10) and (13) into Equation (14), the effective amplitude A can be obtained numerically for either modulus gradient or thickness gradient.

FIG. 15b-d shows the effect of the gradient coefficient a on the buckling behaviors (including the normalized effective shape factors and critical buckling load), as the dimensionless substrate stiffness K̅=Kt₀⁴/D₀ (which demonstrates the relative stiffness of film to substrate) is varied. The critical buckling load N_{cr} and effective amplitude A are normalized by the corresponding values N_{cr}⁰ and A₀ for the reference uniform film without thickness or material gradient (i.e., film with constant thickness t₀ and modulus E₀), where N_{cr}⁰=2(KD₀)^{1/2} and

$${A}_{0} = {{t}_{0} [ \frac{2}{3} ( \frac{N}{{N}_{c}} - 1 ) ]}^{\frac{1}{2}} .$$

When a is zero, the numerical solutions of gradient films agree well with the analytical results of the corresponding uniform film. With nonzero film thickness or modulus gradient, the values of the effective critical wave number m_{cr}, the effective amplitude A, and the critical buckling force N_{cr}, are all lower than their counterparts of uniform film and keep decreasing nonlinearly (which can be fitted in power-law forms in lines) with the increase of film gradient αₜ or α_{E}. In general, the thickness gradient has a larger effect on the critical buckling stress and undulation amplitude than the modulus gradient. However, the wave number is more sensitive to the modulus gradient variation. When the substrate becomes more compliant (i.e., with decreasing K̅), the effective wave number m_{cr} also decreases. Meanwhile, the effect of substrate compliance does not seem to have a major influence on the critical buckling force and amplitude (as long as the film remains much stiffer than the substrate). In all cases as shown in FIG. 15, the theoretical results are compared with FEM demonstrations.

Corresponding plane strain FEM demonstrations (where the substrate is modeled as springs with the same stiffness K) are used to validate the solutions in FIG. 15b-d. By fitting the buckled profiles of FEM demonstrations, the effective shape factors, wave number m_{cr} and amplitude A, can be indirectly determined and compared with the model. All of the parameters governing the buckling behaviors (i.e., N_{cr}, m_{cr}, and A) are obtained when global buckling occurs at a strain level of about 5%. FIG. 15b overall demonstrates that the m_{cr} is slightly higher than that from FEM demonstration, and the error is increased when the gradient coefficient is large. However, N_{cr} and A obtained from demonstrations are somewhat higher than their counterparts. In general, despite the aforementioned assumptions and approximations, the model is validated via its good agreement with FEM demonstrations. This model can be employed to design/control the buckling profiles through engineered film gradients.

In summary, the thickness gradient and/or modulus gradient opens a new door to manipulate spontaneous buckling patterns in thin films on compliant substrates (including curved substrates), leading to the expanded potential applications with tunable surface properties. The following two scenarios are illustrated:

When the uniaxial compression is perpendicular to the gradient direction, Y-branched or multi-branched profiles can emerge for moderate or relatively large gradient slopes, respectively. Meanwhile the undulating wavelength is still uniform along the loading direction. The thickness gradient has a more dominant effect than the modulus gradient. In this case the local buckling wavelength is reasonably close to that of a uniform film (as long as the gradient slope is not too large).

When the compression is along the same direction of material or thickness gradient direction, local to global buckling transition is observed with the increase of the compression, and finally plane strain undulations with nonuniform wavelength and amplitude are formed, where in regions with small wavelength have large amplitude. For this scenario an approximate solution is obtained, and it is found that the critical buckling force N_{cr}, effective critical wave number m_{cr}, and effective deflection amplitude A decrease with the increase of the gradient coefficient a. Compared with the modulus gradient, the thickness gradient has a larger effect on the critical buckling stress and undulation amplitude, but less effect on the wave number. The model is validated by FEM demonstrations, which can effectively show buckling morphologies of gradient films.

These techniques can provide guidance for the design and fabrication of micro-fluidic channel or platform for cell adhesion, where the non-uniform undulation profile, multiple junctions, and tunable surface properties can be obtained through the simple mechanical self-assembly technique via spontaneous buckling of gradient films on compliant substrates.

Some embodiments illustrate exemplary mechanical modeling of a wrinkled fingertip immersed in water

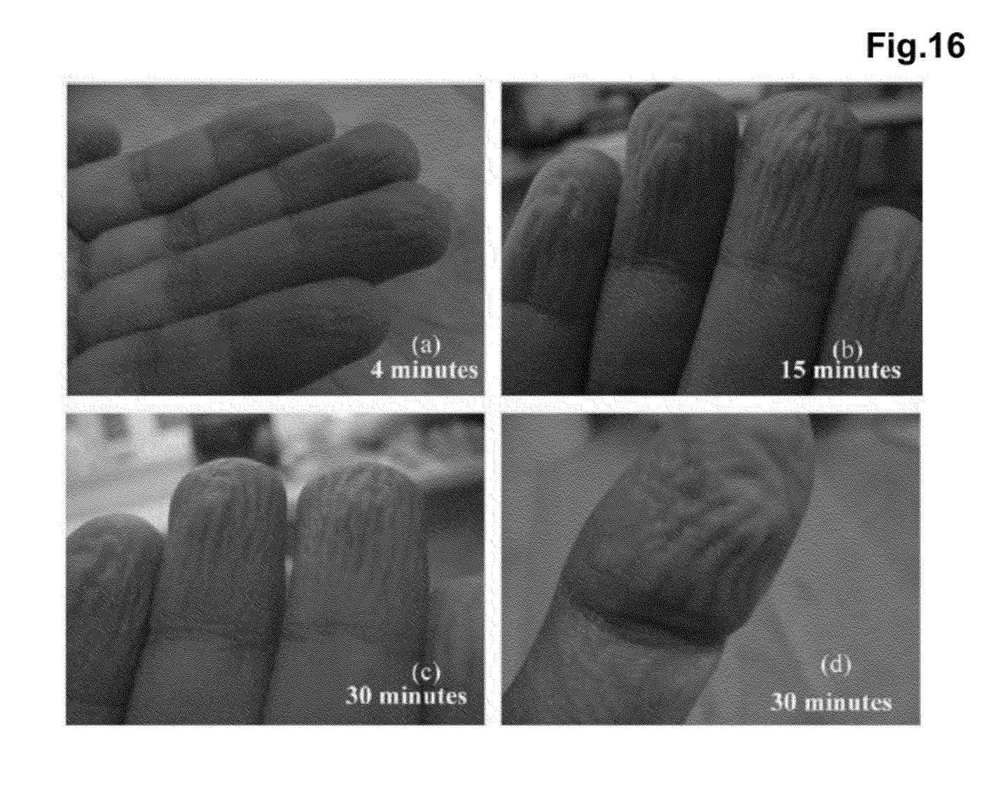

After bathing or swimming, prominent wrinkles are often observed on the skin of human fingertips and toes (FIG. 16). In FIG. 16, after 4 min, wrinkles first appear in the center of fingerpad and are aligned in the longitudinal direction. With prolonged immersion time, wrinkles become more distinct and spread toward the sides and top areas, where some concavities and a few circumferential ridges emerge on top. Finally, the wrinkles evolve into labyrinthine patterns. The wrinkle wavelength remains almost unchanged.

Unlike permanent skin wrinkles due to aging or sunburn, wrinkles caused by water immersion are temporary and diminish upon drying. It has been postulated that swelling in the outermost skin layer, stratum corneum (“SC”) due to osmosis is the main cause of wrinkling. However, this does not explain the absence of wrinkles in the denervated finger. Besides the swelling of the SC, wrinkles could also depend on the change in turgor (finger pulp pressure) in the dermal layer; in essence, the sympathectomy could cause vasodilation and thereby increase turgor, which would suppress the swelling of the SC and reduce wrinkling. The contraction of myo-epithelial cells could also have a role during wrinkling. The wrinkling of a finger upon water immersion could also be due to vasoconstriction, which decreases the turgor and effectively shrinks the tissue volume to produce skin wrinkles. Despite the progress in showing the complicated microscopic physiological cause of finger wrinkling, the macroscopic physical/mechanical principles governing the shape of the wrinkled patterns (such as wavelength and amplitude) are explored. From a fundamental and macroscopic physics/mechanical point of view, the main mechanism of finger wrinkling is caused by the mechanical instability (bifurcation) of the skin due to mismatched deformation between the skin and the underlying tissues, i.e., the relative shrinkage of the underlying tissues with respect to the skin owing to the aforementioned vasoconstriction. The mismatched deformation in compression induces the occurrence of instability in the skin, causing intriguing wrinkle (buckle) patterns to form in the skin of the fingertip.

Exemplary embodiments illustrate the quantitative macroscopic mechanical principles that could explain the overall morphology (shape) of the wrinkles in fingertips upon water immersion. On the fundamental side, recently the mechanics of the buckling of thin film-substrate arrangements has been demonstrated, with diverse potential applications in small-scale fabrications, measurement of film modulus, fruit and plant morphogenesis, and wrinkles in the human skin. However, most previous hypotheses were limited to the buckling of a monolayer thin film deposited on a planar homogeneous substrate. The fingertip incorporates a complex curved topology in geometry and a heterogeneous multilayer skin in structure: the combination of both factors can have a significant effect on the wrinkling morphology. Thus, a better understanding of the mechanical principles of wrinkling of a multilayered film on a curved substrate contributes to the field of solid mechanics. From a practical viewpoint, a detailed mechanistic illustration can elucidate the macroscopic physical/mechanical mechanism governing the overall appearance of skin wrinkling (in particular the pattern and shape of wrinkles) caused by various factors, including water immersion and aging, and identify the most important intrinsic and extrinsic factors/parameters governing the wrinkle morphology. It is therefore possible, from a mechanical point of view, to manipulate or eliminate the macroscopic morphology of skin wrinkles by adjusting certain material parameters. This can be applied to cosmetic science.

From the outmost surface toward the interior, the finger contains multiple layers/components, including the SC, viable epidermis, dermis, subcutaneous soft tissues and bone. The first three layers are the basic components of the skin, and the combination of the first two layers is also known as the epidermis. The SC is the stiffest layer in the skin, and is composed of dead corneocyte cells. The viable epidermis is the living interior layer of the epidermis, and is composed of keratinocyte cells. The dermal layer can be structurally separated into two components: the papillary dermis, mainly composed of bundles of collagen and elastin fibers, and the reticular dermis, formed by a denser network of collagen fibers. Beneath the dermis is the subcutaneous layer, which contains fats as well as areolar tissues.

When exposed to water for a few minutes, water penetration induces vasoconstriction and thus the mismatched deformation between the SC and underlying tissues, and the compressive stress in the SC increases with immersion time. When the stress accumulates to a critical value, wrinkles emerge with a particular pattern and become more prominent with prolonged immersion time. The principle outlined above should apply to the skin of most body parts. However, the water immersion-induced wrinkling process is seemingly and curiously restricted to the palms of the hands or feet, with the tips of the fingers and toes usually being the first to wrinkle. Physiologically, this is because the hand and foot are particularly susceptible sites for vasoconstriction. This is because they have different tissue characteristics, including sweat gland types, number, and tissue turgor, which lead to more prominent sympathetic control of the skin and underlying tissues.

In the example of wrinkled fingers of a healthy young male presented in FIG. 16, the longitudinal ridge-shaped patterns occur first at the center of the finger pad (FIG. 16a). With prolonged exposure to water (FIG. 16b-d), the amplitude of the ridges increases and the wrinkles propagate away from the center of the pad, and local horizontal ridges are observed on the curved finger top (FIGS. 16c and d). Continued extensive exposure to water can produce a labyrinthine wrinkle morphology with a large amplitude. The wrinkle wavelength remains essentially unchanged throughout the process. The average wavelength is about 1 mm on the little finger and about 1.5-2 mm on the thumb in FIG. 16. Note that these typical wavelengths on the fingertips are much larger than the wrinkles found elsewhere (e.g., eye corners, face and volar forearm) caused by aging or external compression. The wrinkles disappear after the evaporation of water inside the skin, resembling a reversible “elastic” deformation.

A reduced finger model is first established with a homogeneous substrate and a relatively simple geometry, so as to focus on the effect of geometrical parameters (including the finger size/curvature and skin thickness) on the macroscopic wrinkle profiles. The wrinkling patterns are quantitatively analyzed using both numerical demonstrations based on the finite element method (FEM) and an analytical approach based on the shell bifurcation principle. Next, a refined anatomical model is established to take into account the exact geometry of a human index finger. More importantly, the effect of the heterogeneous multilayer structure of the skin is explored numerically and analytically. Mechanical/material ways to manipulate the wrinkle patterns are illustrated based on the mechanics principles disclosed herein.

In some embodiments, a reduced model is established that illustrates the effect of finger size/curvature and SC thickness.

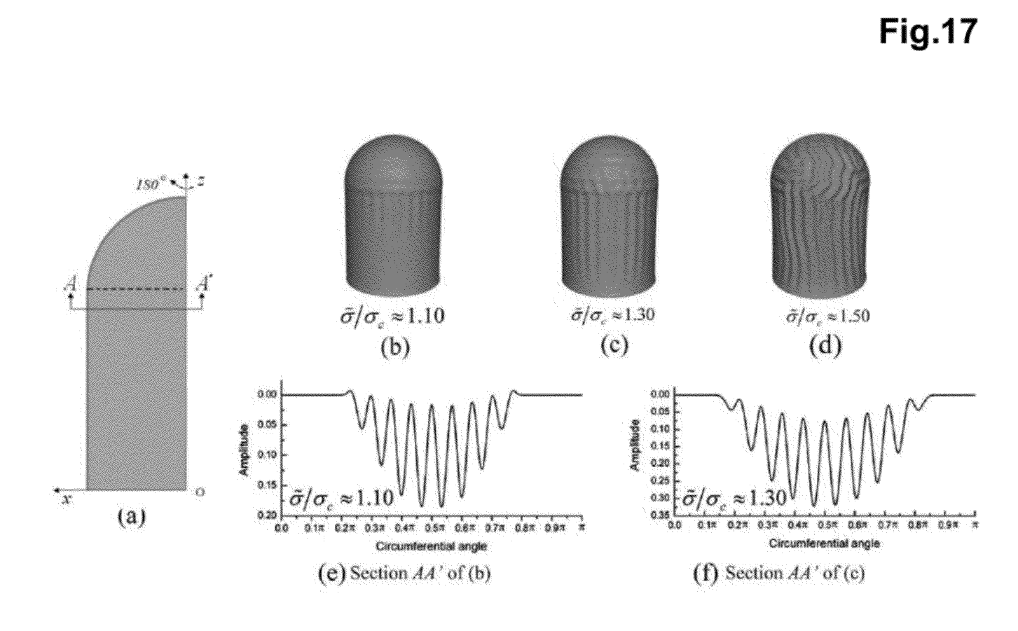

With reference to FIG. 17, (a) is an exemplary schematic of the model. The model is created by a half-cylinder and a half-sphere, where the grey color represents the homogeneous substrate and the gold film represents the SC layer. The deformation shapes of wrinkles with increased stress are shown in (b), (c) and (d), where the stress level varies from 1.1 to 1.5. The circular section deformation of AA′ is also shown in (e) and (f).

In one embodiment, a simple reduced model of the fingertip is given in FIG. 17a, which consists of a half-cylinder (with radius R and length 2R) with a smooth half-spherical head, resembling the finger pad and the more curved finger top, respectively. As a first-order approximation, the SC is assumed to be a homogeneous elastic thin film with Young's modulus E and thickness t (see Table 1 for typical values, t<<R). In order to gain insight into the most important mechanical factors governing the wrinkling process, a simplified “first-order” model is used where the materials are assumed to be linear elastic and skin stiffening is neglected with strain. Due to the limited data available on the mechanical properties of hydrated fingertip layers, all material properties adopted are those without water immersion. One purpose of the reduced model is to illustrate the effect of geometrical factors of the model on wrinkling behaviors, the multilayered structures underlying the SC can be simplified as a homogeneous and elastic soft substrate. The thickness tₛ of the homogeneous substrate is taken to be tₛ=R=7.5 mm The substrate's effective Young's modulus (Eₛ) is determined by the weighted average of the elastic modulus of the individual underlying layers. It is assumed that the Poisson's ratio of the SC and underlying substrate are the same, v=0.48. The film is assumed to remain bonded with the substrate throughout the entire process.

Upon mismatched deformation, the film undergoes compression and will wrinkle/buckle beyond a threshold. Such a mismatched deformation can be caused by the relative shrinkage of the substrate (underlying tissues) in the case of vasoconstriction upon immersion of a fingertip in water. Mechanically, the relative shrinkage of the underlying substrate is equivalent to the relative swelling of the film that would produce the same compressive stress state in the film that would lead to the same buckling morphology. This broadens the application of the present model. We assume the mismatched deformation to be isotropic and uniform, which can be analogously illustrated without any external guidance, where the relative mismatch deformation rate is denoted as a. It is assumed that the vasoconstriction of the underlying tissues with respect to the immersion time T is linear before the onset of wrinkling. Denote the magnitude of the maximum compressive in-plane pre-buckling stress component of the film as σ, σ∝αT. When σ exceeds a critical value σ_{c} (or, equivalently, when the immersion time reaches the critical value of Tₐ), wrinkles start to form. Therefore, the normalized stress σ/σ_{c} is also a parameter that effectively describes the immersion time.

Among the primary parameters characterizing the wrinkling process, the critical wrinkle stress (σ_{c}) or wrinkle strain (εₛ)) determines the susceptibility to wrinkle initiation, and the wrinkle-to-wrinkle distance (i.e., wavelength) and the wrinkle depth (i.e., deflection amplitude) depict the profile (morphology) of a wrinkle. Variation of these parameters with respect to the geometrical and material properties (i.e., with varying R, t and E/Eₛ of the reduced model) are discussed below.

TABLE 1
Typical geometrical and mechanical parameters of individual layers
of a fingertip, where the material properties differentiate the
multi-layered model from the homogenous reduced model.

| | | Viable | | Subcu- | |
|---|---|---|---|---|---|
| | S.C. | epidermis | Dermis | taneous | Bone |
| Elastic modulus | 3 | 0.136 | 0.08 | 0.034 | 17,000 |
| (MPa) (Multi- | | | | | |
| layered model) | | | | | |
| Elastic modulus | 3 | 0.136 | 0.136 | 0.136 | 0.136 |
| (MPa) (Reduced | | | | | |
| homogeneous | | | | | |
| model) | | | | | |
| Poisson's ratio | 0.48 | 0.48 | 0.48 | 0.48 | 0.48 |
| Thickness (mm) | 0.15 | 0.12 | 1.16 | 3.86 | 4.2 |

Illustrations of wrinkling patterns of the reduced model are described. FIG. 17b-d shows the illustrated wrinkling process of the reduced model with immersion time (E/Eₛ=30). When σ/σ_{c} is just above 1.0, the peak stresses are found near the center of the finger pad where the longitudinal wrinkles emerge. With prolonged immersion time (i.e., increased σ/σ_{c}), more wrinkles emerge, and longitudinal waves and dot-like ordered concaves are observed on the cylindrical pad and the spherical top, respectively. When σ/σ_{c} is very large (after long-time immersion), a labyrinthine pattern emerges on the spherical top and the longitudinal ridges become curved.

The different wrinkle patterns can be qualitatively explained as the competition between the compressive hoop stress σₕ and longitudinal stresses σₗ in the film, the ratio of which at any point can be expressed as σₕσₗ=2−R₂/R₁ with R₁ and R₂ being the principal radii of curvature of the curved film. For the cylindrical finger pad (R₁=∞, R₂=R at any point), σₕ=2σₗ, which renders the orientation of undulations perpendicular to the hoop direction (to release the larger stress component). For the spherical tip (R₁=R₂) σₕ=σₗ, and the concave dimples emerge to release stresses in all directions. With extensive exposure to water, the concave dimple pattern transits to a labyrinthine pattern to release stress in all directions.

The wrinkle shapes of the reduced model agree qualitatively with the macroscopic observation illustrated in the embodiment of FIG. 17. For a real finger, since the radius of curvature along the longitudinal direction is larger than that along the hoop direction (R₁>R₂) in the fingertip pad, and according to the mechanical principle above, the wrinkles in the longitudinal direction dominate. Such dominance fades away near the very top of the finger, where the principal curvatures are close to each other.

FIGS. 17b and c also show the deformed amplitude of the finger pad (the half-cylinder section of the reduced model). The wrinkles are distributed uniformly in the finger pad and the wavelength remains almost constant with increasing σ/σ_{c} (although more wrinkles appear in larger surface areas with prolonged immersion). Due to the boundary effect, the wrinkle amplitude is the largest near the center of the finger pad, and decays away near the two sides. The wrinkle amplitude increases with the stress level in the SC.

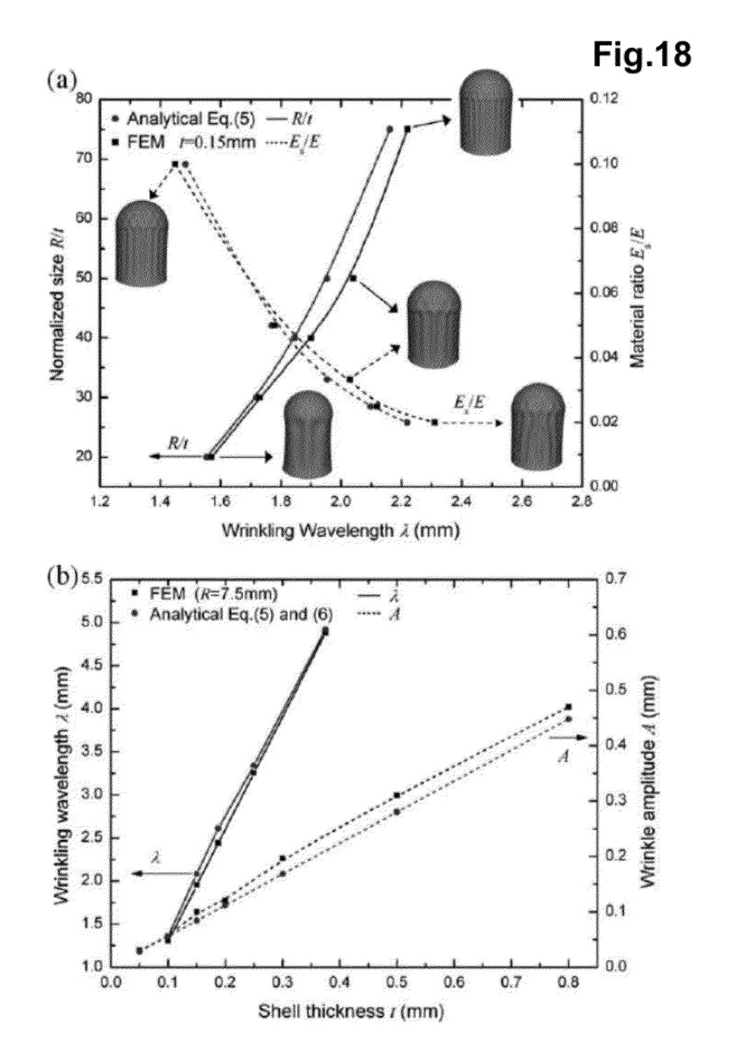

Demonstrations in FIG. 17 are based on the parameters in Table 1, which represent typical values of the reduced model of the fingertip. Note that the material and geometrical parameters (R, t, E/Eₛ) can vary for different fingers (e.g., thumb vs. little finger) and for different people/ages. These parameters are varied next, and the resulting wrinkle wavelength and amplitude of the reduced model are shown in FIG. 18.

With reference to FIG. 18, the embodiment in (a) shows that the wrinkle wavelength varies with the normalized size R/t (t=0.15 mm, Es/E=0.033) and material ratio Es/E (t=0.15 mm, R/t=50). Several typical deformation shapes of wrinkled models are also shown at the same stress level (\tilde{σ}/σ_{c}). The embodiment in (b) shows the wrinkle wavelength (R=7.5 mm, Es/E=0.033) and shows that the amplitude varies with the SC film (shell) thickness t.

In FIG. 18a, the wavelength increases nonlinearly with R/t and E/Eₛ. In FIG. 18b, the amplitude is taken at the pad center and at a stress level of σ/σ_{c}=1.2, showing that the amplitude increases almost linearly with film thickness. In order to explain these results quantitatively, the effects of geometrical and material parameters on wrinkling characteristics can be deduced from an analytical approach.

For a thin film with arbitrary principal curvatures in Cartesian coordinates, according to the thin shell principle, the governing equilibrium and compatibility equations can be expressed as

$$\begin{matrix}D {∇}^{4} w - ( {Φ}_{yy} {w}_{xx} + {Φ}_{xx} {w}_{yy} - 2 {Φ}_{xy} {w}_{wy} ) - {∇}_{k}^{2} Φ = - p & ( 15 ) \\ \frac{1}{Et} {∇}^{4} Φ = {w}_{xy}^{2} - {w}_{xx} {w}_{yy} - {∇}_{k}^{2} w & ( 16 )\end{matrix}$$

Here, w=w(x,y) is the deflection of the film. ( )ₓ=∂( )/∂x denotes differentiation with respect to x. Φ is the Airy stress function, its derivatives yielding the in-plane stresses. p is the interface pressure acting on the film (SC) arising from the constraint of the substrate (underlying layers and tissues). D=Et³/12(1−v²) and Et are the bending and stretching stiffness of the film, respectively. ∇⁴ is the bi-harmonic operator. ∇ₖ² is defined as ∇ₖ²( )=( )_{yy}/R₁+( )ₓₓ/R₂.

The homogeneous substrate can be further simplified as a linear elastic foundation with p varying linearly with w, i.e., p=kw, where k=\tilde{E}ₛ/tₛ is denoted as the foundation stiffness with \tilde{E}ₛ=(1−v)Eₛ/(1−2v)(1+v) and tₛ is the substrate thickness. Through classical linear stability analysis, by eliminating the Airy stress function, the general stability equation governing the deflection of the thin film can be obtained:

D∇⁸w+Et∇ₖ⁴w=∇⁴f (17)

where ∇⁸( )=∇⁴∇⁴( ), ∇ₖ⁴( )=∇ₖ²∇ₖ²( ) and f=Nₓ⁰wₓₓ+2N_{xy}⁰w_{xy}+N_{y}⁰w_{yy}−kw. Nₓ⁰, N_{y}⁰ and N_{xy}⁰ are the initial in-plane forces (applied by the substrate). Given the deflection mode w(x,y) and substrate curvature, the critical buckling load and wavelength can be obtained.

The shape of a real fingertip is somewhat irregular, which makes it hard to solve the Eq. (17) analytically. Note that after water exposure, according to both observation (FIG. 16) and demonstration (FIG. 17), the wrinkle wavelength is uniform along the hoop direction and remains unchanged during the wrinkling process. Thus, some insight can be obtained by focusing on a whole cylindrical film/substrate arrangement, the geometry of which is also consistent with the reduced model (half-cylinder) illustrated above.

For the cylindrical film/substrate arrangement with section radius R, the film (hoop) stress in the pre-buckling state can be obtained from the deformation compatibility at the film-substrate interface:

$$σ = - \frac{{EE}_{s} ( 2 {R}^{2} + 2 Rt + {t}^{2} ) α T}{2 {E}_{s} {R}^{2} + [ {E}_{s} ( 1 + v ) + E ( 1 - v ) ] ) 2 Rt + {t}^{2} )} \qquad ( 18 )$$

The positive value of the relative mismatched deformation rate a leads to the compressive stress in the film. Eq. (18) demonstrates that the pre-buckling compressive stress in the depends only on the mismatched deformation aT when the material and geometry parameters are fixed.

For simplicity, the interface shear stress is neglected. The deflection mode can be expressed as w(x,y)=A sin(mp x/L)sin(ny/R), where A is the deflection amplitude, m and n are the half-wave number along the longitudinal and circumferential directions, respectively, and L is the cylinder length. Substitution of the deflection mode with R₁=∞ and R₂=R in Eq. (17) and minimization can lead to the critical wrinkle wavelength and critical stress:

$$λ = 2 π {t ( \frac{R}{t} )}^{\frac{1}{4}} {( \frac{\overline{E}}{12 {\overline{E}}_{s}} )}^{\frac{1}{4}} and {σ}_{c} = {( \frac{{\overline{EE}}_{s}}{3} )}^{\frac{1}{2}} {( \frac{t}{r} )}^{\frac{1}{2}} \qquad ( 19 )$$

where Ē=E/(1−v²). The wrinkle amplitude can be obtained from the deformation compatibility between the SC and its underlying substrate,

$$A = \frac{λ}{π} {( Δ ɛ )}^{\frac{1}{2}} \qquad ( 20 )$$

where Δε is an imposed strain caused by mismatched deformation. The scaling law in Eq. (20) is in the same form as that in other techniques. Eqs. (19) and (20) predict that within the present macroscopic mechanical model, the critical wrinkling stress, wrinkle wavelength and amplitude depend only on the geometry and material properties of the arrangement, and are independent of the mismatched swelling/shrinking rate.

FIG. 18 shows the good agreement of wavelength and amplitude between the analytical predictions (Eqs. (19) and (20)) and the FEM demonstration results of the reduced model. FIG. 18a shows that when the film thickness is kept constant (t=0.15 mm) the wrinkle wavelength increases nonlinearly with R/t and E/Eₛ, which agrees with the analytical result in Eq. (19). When the material properties and finger radius are fixed, the non-linear increasing trend of the wavelength with the film thickness is also consistent with Eq. (19), as shown in FIG. 18b. FIG. 18b also demonstrates that the wrinkle amplitude increases almost linearly with the thickness when the material properties are fixed (at the same film stress level), with good agreement with the analytical prediction (Eq. (20)).

From the above equations, several important insights can be obtained on the external factors affecting the fingertip wrinkling process. In general, the critical time to wrinkle T_{c}, can be an important parameter for the bedside test of sympathetic innervation, can be shortened by increasing the water temperature and pH. Through the combination of Eqs. (18) and (19), it can be shown that when the material properties are fixed, T_{c} is proportional to the SC thickness and inversely proportional to the fingertip radius and the relative mismatched deformation:

$${T}_{c} ∝ ( t , \frac{1}{R} , \frac{1}{α} ) \qquad ( 21 )$$

In essence, a higher temperature could increase the fluid diffusion rate and thereby increase vasoconstriction (i.e., increase a, which would shorten the time to wrinkle according to Eq. (21). The same effect is found for increasing pH, where the water-binding capacity is enhanced and a is increased. On the other hand, it was observed that the water temperature had no effect on the degree of wrinkling (i.e., the spacing between the peaks and valleys is insensitive to water temperature). This can be validated from Eq. (19), where the resulting wrinkle wavelength is independent of a, which means that temperature cannot affect the wrinkle wavelength (although it can affect the vasoconstriction process and hence a).

The equations above also provide important mechanical information into the wrinkle patterns in the fingertips and different parts of the human body (with different parameters R, t and E/Eₛ). Reduced fingertip wrinkles (due to water immersion) are found in manual workers who have a thicker SC. This can be explained by Eq. (19), since the thicker SC results in an increase in the wrinkle wavelength (i.e., there is a reduced number of wrinkles); it also increases the critical time to wrinkle (i.e., the wrinkles are more difficult to form), as indicated by Eq. (21). For another example, the larger wavelength observed on the thumb than on the little finger can be explained from Eq. (19), which predicts that the wrinkle wavelength increases with the substrate radius when assuming the material properties are the same for the five fingers.

From the mechanics perspective, the curiously restricted wrinkle areas of the palms of the hands or feet upon immersion in water can be explained by the onset of wrinkling in Eq. (19). The evolution of stress (Eq. (18)) is mainly associated with the relative mismatched deformation rate a in the case of immersion in water. Compared with the fingertips, palms and soles, the value of α in the other parts of human body is much smaller (due to the aforementioned physiological reasons owing to the different tissue characteristics), which makes them take a much longer time to reach the critical wrinkling stress under the same conditions. In addition, Eq. (19) also implies that the wrinkle wavelength is influenced more greatly by the SC thickness than by the material properties. For most skin areas covering a human body, the SC is quite thin, on the order of 10-20 lm. However, the SC is about 12-40 times thicker on the fingers, soles and palms—which is also the thickest in the body. According to the mechanical scaling law in Eq. (19), it can be observed from the wrinkle wavelength on the fingertips (1-2 mm in FIG. 16) that, when other conditions remain the same, the wrinkle wavelength is about 0.05-0.15 mm in other areas of the body (due to the thinner SC), which is qualitatively consistent with observation (e.g., the average wrinkle wavelength on eye corners is ˜0.075-0.3 mm). The validation of the mechanics principle implies that, when the whole body is immersed in water for a few minutes, other body parts are either unlikely to reach the critical wrinkling stress or the wrinkle wavelength is too small to be visible, while wrinkles are more achievable and prominent on the fingertips and toes.

Some embodiments illustrate a full model that illustrates the effect of multilayered finger structure.

Although the reduced model embodiments show reasonable agreement with observation and uncover the important geometric/material parameters governing wrinkle appearance, the following embodiments illustrate how the underlying layered structure of the skin/tissue would affect the wrinkling behaviors of the fingertips. Therefore, a refined three-dimensional (3-D) model is developed based upon the anatomical structure of the human fingertip. The model's non-linear exterior geometry is created from caliper measurements of a plaster of Paris mold. The mold's shape is formed from the distal phalange of the index finger of a young male who anthropologically fits the 50th percentile. Twenty-one key measurements of the mold inform the geometric model, the first being the length of the finger digit from the skin crease to the tip. The other 20 measurements are made perpendicular to the axis of the finger, 10 each for width and height. The lateral increments for width and height measurements at the 10 locations decrease from ¼ to 1/16 of an inch nearer the more curved region of the fingertip. More details of the parameterization of the anatomical model can be found elsewhere.

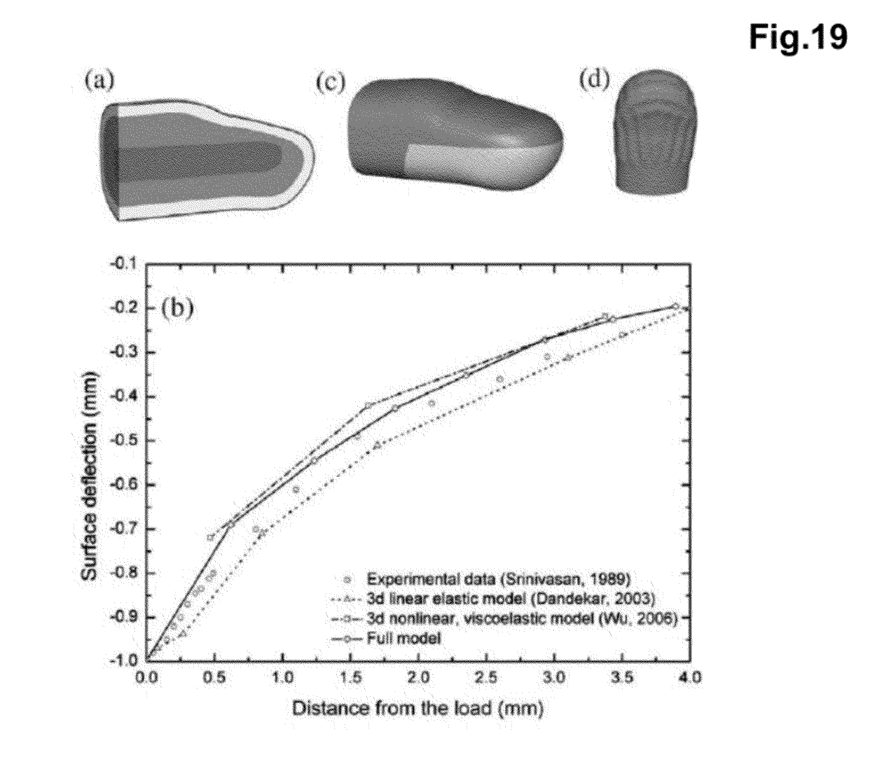

FIG. 19a illustrates the anatomical structure, the overall cross-section of which can be roughly viewed as an ellipse, with its major and minor diameters being 18.2 and 14.2 mm, respectively. All five layers—the SC, viable epidermis, dermis, subcutaneous tissues and bone—are incorporated in the refined (full) model. Each interior layer is offset from the external layer by a specified thickness value. As a first-order approximation, all layers are assumed to be homogeneous, isotropic and linear elastic. The thickness and elastic modulus of all the layers/components are shown in Table 1. The geometry is meshed layer by layer from the epidermis through to the bone.

The full model utilizes linear elastic material properties that are representative of tissue layers measured in human cadavers. Other 3-D models of the fingertip have been built, some employing hyper- and viscoelastic material models. The present full model in FIG. 19b is first validated, where a 50 μm line load that spans the width of the finger is indented to a depth of 1.0 mm, perpendicular to the long axis of the finger.

Next, FEM wrinkling demonstrations are carried out on the full model. Since wrinkles are often found within the region of the finger pad, only the pad area (grey region) is allowed to respond to the mismatched deformation as shown in FIG. 19c (due to vasoconstriction). FIG. 19d shows a illustrated typical wrinkled fingertip with the full model (at σ/σ_{c}=1.15), where the wrinkle wavelength is about 2.6 mm. The wrinkled shape is consistent with the observation in immersed water (FIG. 16).

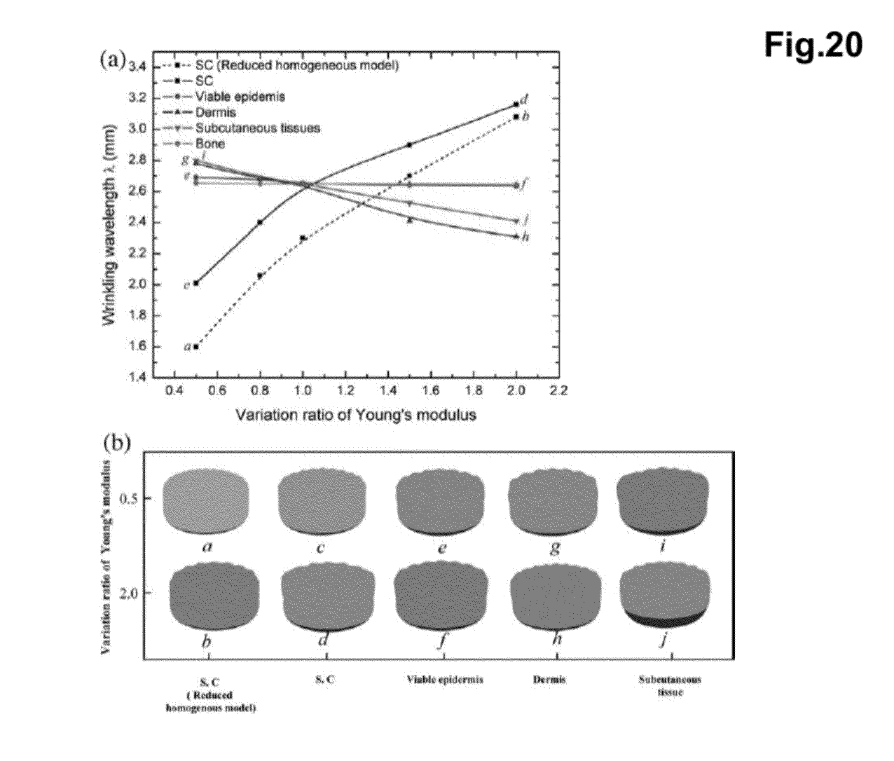

While the material properties tabulated in Table 1 (which are used in the embodiments of FIG. 19) represent that of a typical fingertip, note that elastic properties of skin vary with hydration, dehydration, sunburn and intrinsic aging, and could affect the wrinkling characteristics. In what follows, the effect of variation in the elastic property of each layer is illustrated, which can lead to techniques for manipulating skin wrinkles due to water immersion. In FIG. 20, the Young's modulus of each of the five layers varies from half to twice its original value (Table 1), while other layers are kept unchanged. FIG. 20a shows the resulting variation in the wrinkle wavelength obtained from the FEM demonstration of the full model (solid lines). Compared with the reduced model with a homogeneous substrate (dash line), the wrinkle wavelength is larger in the full model.

Among the five layers in the full model, the variation in the SC modulus has the largest impact on the wrinkle wavelength and the wavelength increases with stiffening of the SC layer, whereas the variation in the bone modulus on the wrinkle wavelength is negligible. The variation in the stiffness of the viable epidermis layer has almost no effect on the wrinkle wavelength of the fingertip even though it is adjacent to the SC, indicating its minor mechanical role in the wrinkling process. The wavelength decreases with increasing stiffness of the dermal and subcutaneous tissues—it appears that, among the underlying compliant layers, the dermis has the biggest impact on the wrinkle wavelength. FIG. 20b shows the relevant deformed morphology of the cross-section of the full model of the fingertip at the same stress level (with σ/σ_{c}=1.15) when the modulus of the corresponding layer is halved or doubled. The section morphology shown in the figure demonstrates that the amplitude increases linearly with the wavelength, and the relevant demonstration results are consistent with Eq. (20).

A qualitative explanation of the effect of the underlying layers can be sought from a multilayer analytical composite model. Denote the thickness of the viable epidermis, dermis, subcutaneous soft tissue and bone as tᵥ, t_{d}, tₜ and t_{b}, respectively, and their moduli as Eᵥ, E_{d}, Eₜ and E_{b}, respectively. As remarked upon earlier, in the reduced model, the effective Young's modulus of the substrate is Eₛ, which can be expressed as 1/Eₛ=tᵥ/tₛEᵥ+t_{d}/tₛE_{d}+tₜ/tₛEₜ+t_{b}/tₛE_{b} with tₛ=tᵥ+t_{d}+tₜ+t_{b} the total thickness of the layers below the SC. According to Eq. (19), for a layered composite substrate, after the substitution of R=tₛ, the wrinkle wavelength λ_{f} and critical wrinkling stress σ_{f} in the full-scale model are

$$\begin{matrix}{λ}_{f} ∝ {E}^{\frac{1}{4}} {{t}^{\frac{3}{4}} ( \frac{{t}_{v}}{{E}_{v}} + \frac{{t}_{d}}{{E}_{d}} + \frac{{t}_{t}}{{E}_{t}} + \frac{{t}_{b}}{{E}_{b}} )}^{\frac{1}{4}} & ( 22 ) \\ {σ}_{f} ∝ {E}^{\frac{1}{2}} {{t}^{\frac{1}{2}} ( \frac{{t}_{v}}{{E}_{v}} + \frac{{t}_{d}}{{E}_{d}} + \frac{{t}_{t}}{{E}_{t}} + \frac{{t}_{b}}{{E}_{b}} )}^{- \frac{1}{2}} & ( 23 )\end{matrix}$$

In Eqs. (22) and (23) the influence of the substrate radius R is cancelled out in the multi-layered model, which implies that Eqs. (22), (23), and (20) are also applicable to the wrinkle of skins on planar substrates.

Eq. (22) shows that in general, the wavelength decreases with the Young's modulus of the underlying soft layers and increases with that of the SC. These trends agree with that shown in FIG. 20a. The qualitative effect of individual layer's stiffness on the wrinkling behavior can be deduced from Eqs. (20), (22), and (23). Taking the viable epidermis as an example, its modulus is larger than other underlying layers (Eᵥ≈2E_{d}≈4Eₜ) yet its thickness is very small (tₜ≈3t_{d}≈30tᵥ). According to the above equations, the change in the viable epidermis's stiffness has negligible effects on the wrinkle wavelength and critical wrinkling stress. Similarly, since the bone's Young's modulus is much larger than that of the other layers, the influence of the bone stiffness on the wrinkling characteristics can also be omitted. Thus, the effective modulus of the substrate is determined mainly by the dermal and subcutaneous layers.

From the mechanical scaling law in Eq. (22), the qualitative effect of the thickness variation can be predicted in a similar way: the wrinkling wavelength will increase with the thickness of the underlying tissue layers. Among the four underlying layers, thickness variations in the viable epidermis and bone have negligible influence because of their larger moduli. Thickness variations in the SC and dermal layer play a more important role in manipulating the wrinkle wavelength.

In some embodiments, the mechanical model can be applied to embodiments beyond water immersion. Some of the unveiled basic mechanical principles can be qualitatively applied to general skin wrinkles. In essence, the wrinkles can be caused by the mismatched deformation between the film and the substrate, regardless of whether such a mismatched deformation is due to vasoconstriction (in the case of the immersion of a fingertip in water), skin swelling with respect to the tissue, mismatched evolution of skin/tissue properties or mechanical stress in other types of applications. In one embodiment, the focus is on skin aging.

Skin wrinkles, often observed on the face, eye corner, forehead and neck, are the inevitable result of natural aging or extrinsic factors such as smoking and chronic sun exposure. Wrinkles occur when skin is deformed due to muscle contraction or mechanical forces. Skin aging and wrinkling involve complicated biological, biochemical and physiological processes at the cellular and tissue scales, which result in distinct alterations in collagen and elastic fibers. The mechanical aspects are as follows.

Aging causes changes in the organization and composition of skin throughout the epidermis, dermis and subcutaneous tissues, which greatly affect the mechanical properties and layer thickness. Wrinkles are thin (i.e., small wavelength), numerous and of low amplitude in young skin, while in aged skin they are wider, fewer and of higher amplitude. Although the aging and wrinkling processes are different from the reversible wrinkles caused by the immersion in water of fingertips and toes, from the mechanical point of view, the buckling mechanism is similar because the buckles are caused by compression of the skin, owing to the mismatched deformation between the skin and the underlying tissues.

In the full fingertip model with a multilayered skin/tissue structure, since the substrate curvature has no effect on determining the wrinkle wavelength (Eq. (22)), wrinkle amplitude (Eq. (20)) or critical wrinkling stress (Eq. (23)), some of the previously established mechanical principles can be safely applied to skin wrinkles in facial and other, “flatter” regions.

With aging or sun exposure, large changes can occur in the thickness and mechanical properties of the skin. A continuous reduction of the overall skin thickness can be observed after 20-30 years of age, whereas the thickness of the SC hardly changes at all with age. Meanwhile, a progressive increase in the thickness is observed in the papillary dermis region with aging or exposure to the sun. This region, termed the subepidermal non-echogenic band (SENEB), is characteristic of aging.

From Eq. (22) and the discussion in Section 4.2, when the thickness of the SC remains unchanged, the change in the thickness of the dermis layer in the skin has the greatest influence on the wrinkling of the skin. In other words, the progressive increase in the thickness of the dermis layer leads to the enlargement of the wrinkle wavelength and thereafter prominent wrinkles. In addition, from the same mechanical principle, the thickening of the dermal layer/SENEB could also reduce the wrinkling stress, which makes wrinkles appear more easily.

The reduced elasticity and extensibility of skin with aging leads to the increase in overall Young's modulus of skin, especially in the epidermis, while the dermal layer becomes less stiff with aging, primarily due to the loss of collagen and elastin. Similarly, from Eq. (22), the combination of the increasing modulus in the SC and the decreasing stiffness in the dermal layer can lead to a larger wrinkle wavelength with aging. From the mechanical point of view, the full multilayer model provides a plausible explanation for the macroscopic characteristics of skin aging and skin wrinkles.

The previous understanding of the mechanics of wrinkling can provide insight into the suppression/slowing down or removal of wrinkles using mechanical or material approaches through a reverse analysis. The “anti-aging” goal of cosmetic products is to prohibit or slow down the wrinkling process, whereas those cosmetics designed for “wrinkle removal” aim to make the existing wrinkles finer and less prominent/visible. From the mechanical perspective, the wrinkle process can be slowed down (or prohibited) if the critical wrinkling stress is increased (see Eq. (23)), whereas the wrinkle removal process is equivalent to reducing the wrinkle wavelength and amplitude (see Eqs. (20) and (22)).

For the design of anti-aging cosmetic products (for skin), inspired by Eq. (23), stiffening the SC and the underlying skin layers can contribute to the increase in the critical wrinkling stress. The stiffening of the SC includes the increase in the modulus and the thickness. The incorporation of biocompatible nanoparticles into the skin is one way to increase the modulus of the SC. Compared with the variation in modulus, the thickness of the SC has a larger effect on increasing the critical wrinkling stress in terms of Eq. (20), which can be consistent with the rare observation of aging wrinkles on horny skin. Thus, certain cosmetic products designed to increase the SC thickness, or simply an appropriate coating on top of the SC (e.g., lip cream), can effectively increase the critical wrinkling stress and make it harder for the wrinkles to appear.

Another technique for anti-aging is to increase the modulus of the underlying layers in the skin. Increasing the modulus of the dermal layer is the most effective way to lead to a larger critical wrinkling stress (demonstrated in Section 4.2), which is also consistent with the current cosmetic design strategy. The main components of most anti-aging cosmetic products are organic nutrients such as vitamins A, C and E and alpha-hydroxy acid: these active ingredients must penetrate the SC and target the cells in the dermis layer in order to proliferate and increase the number of collagens and elastins, resulting in an increase in the elasticity of the dermal layer and thereby raising the critical wrinkling stress.

For the design of wrinkle removal cosmetic products, in terms of the discussion in Section 4.2 and Eqs. (20) and (22), the effective ways are to decrease the stiffness of the SC or increase the stiffness of the underlying skin layers. The key aspect in the design of suitable cosmetic products is to maintain the barrier function of the SC while providing hydration and nutrition to the skin. Most current wrinkle removal products on the market contain a variety of moisturizers, which are used to maintain or supply the water content in the skin to keep its elasticity. With the application of moisturizers, the Young's modulus of the SC will decrease substantially, thereby decreasing the wrinkle wavelength and also the amplitude to make the wrinkles less visible. This strategy is consistent with the fact that hydrated SC results in a lower depth of wrinkles. According to the mechanical principles, an efficient technique for wrinkle removal is to stiffen the dermis or decrease its thickness. This strategy is also consistent with wrinkle suppression discussed above.

A numerical demonstration is performed to understand the physical mechanism governing the macroscopic morphology of wrinkling of fingertips immersed in water. The model is based on the physiological cause, where the vasoconstriction of substrate tissues leads to mismatched deformation between the film (skin) and the substrate, rendering the film in compression and causing the wrinkle morphology. Illustrations based on both reduced and full fingertip models are used. It is found that, with increased exposure to water, the wrinkles first emerge in the center of the finger pad, form a ridged pattern and propagate towards the end of the fingertip, finally evolving into a labyrinthine morphology. The effects of finger geometry and elastic properties on the wrinkle characteristics (the critical wrinkling stress/strain, wrinkle wavelength and wrinkle amplitude) are derived explicitly from the reduced model. The wrinkle wavelength increases nonlinearly with the finger radius/thickness ratio and SC/substrate moduli ratio, and the wrinkle amplitude increases linearly with the wrinkle wavelength. Reasons why the wrinkles are restricted to the skin of the fingertip, palm and sole are given based on the mechanical perspectives of the reduced model.

A multilayered full model further reveals the role of the individual underlying layers' material properties and thickness on the wrinkle wavelength, where the variation in the SC and dermis has the greatest effect. The influence of the viable epidermis and the inner rigid bone is negligible. Based on the mechanical principles disclosed herein, qualitative methods into the suppression or removal of wrinkles of the skin caused by aging are obtained. From a mechanical/material perspective, stiffening of the SC and the dermal layer can increase the critical wrinkle stress (for anti-aging), whereas increasing the dermal layer's modulus and decreasing the SC's stiffness can lead to finer wrinkles (smaller wavelength) with lower wrinkle depth/amplitude (for wrinkle removal).

Although the original mechanical model is based on the vasoconstriction of the substrate (due to water immersion), the model is broad and can be readily applied to illustrate the skin (film) wrinkle morphology in other general cases. From the mechanical point of view, wrinkle profiles are similar to films that undergo similar compression due to other types of mismatched deformation, which can have other causes, such as relative skin swelling or aging. As an illustration of the extended application, the model can be used to provide qualitative techniques into general skin wrinkling due to aging and how to suppress the wrinkles using mechanical/material techniques.

The techniques have potential biomedical applications in the human sense of touch and the design of artificial skin. In contrast to skin wrinkles caused by compressive stress, skin cracks due to dryness are often observed (e.g., in heels and lips in winter) to be caused by tensile stress in skin.

The foregoing merely illustrates the principles of the disclosed subject matter. Various modifications and alterations to the described embodiments will be apparent to those skilled in the art in view of the teachings herein. It will thus be appreciated that those skilled in the art will be able to devise numerous techniques which, although not explicitly described herein, embody the principles of the disclosed subject matter and are thus within the spirit and scope thereof.

1. A system for creating and self-assembling a three-dimensional buckle pattern in a film having at least one deformation property and bonded to a substrate having at least one deformation property which is different than the at least one film deformation property, comprising:
a receptacle for receiving the substrate and bonded film; and
a buckling component, coupled to the receptacle and configured to alter the at least one deformation property of the substrate and/or the at least one deformation property of the film according to one or more tunable parameters, to thereby cause the film to buckle in a three dimensional pattern.

2. The system of claim 1, wherein the substrate comprises a substrate having a shape selected from the group consisting of a curved plane, cylinder, sphere, hemisphere, spheroid, cone, and combinations thereof.

3. The system of claim 1, wherein the substrate comprises a substrate having a cylindrical shape, and the buckling component is further configured to alter the at least one deformation property of the substrate and/or the at least one deformation property of the film to thereby cause a gear shaped buckle pattern to be formed.

4. The system of claim 1, wherein the substrate comprises a substrate having a cylindrical shape, and the buckling component is further configured to alter the at least one deformation property of the substrate and/or the at least one deformation property of the film to thereby cause a spring shaped buckle pattern to be formed.

5. The system of claim 1, wherein the substrate comprises a substrate having a hemispheric shape, and the buckling component is further configured to alter the at least one deformation property of the substrate and/or the at least one deformation property of the film to thereby cause a ribbon shaped buckle pattern to be formed.

6. The system of claim 5, wherein the ribbon-like shaped buckle pattern comprises photodetectors.

7. The system of claim 1, wherein the buckling component is configured to alter the at least one deformation property of the substrate and/or the at least one deformation property of the film by one or more of differential growth, thermal expansion mismatch, electric field-responsive deformation mismatch, phase transformation-induced strain mismatch, swelling or dehydration mismatch, osmotic pressure, and environmental pH variation.

8. The system of claim 1, further comprising:
a parameter component, coupled to the buckling component, and configured to set the one or more tunable parameters, wherein the one or more tunable parameters are selected from the group consisting of buckling stress, buckling amplitude, buckling shape, and buckling wavelength.

9. The system of claim 1, wherein the buckle pattern comprises a pattern to adjust wetting properties of a nanopore.

10. A method for creating and self-assembling a three-dimensional buckle pattern in a film having at least one deformation property and bonded to a substrate having at least one deformation property which is different than the at least one film deformation property, comprising:
receiving the substrate and bonded film; and
altering the at least one deformation property of the substrate and/or the at least one deformation property of the film according to one or more tunable parameters to thereby cause the film to buckle in a three dimensional pattern.

11. The method of claim 10, wherein the substrate comprises a substrate having a shape selected from the group consisting of a curved plane, cylinder, sphere, spheroid, cone, and combinations thereof.
The method of claim 10, wherein the altering comprises altering by one or more of differential growth, thermal expansion mismatch, electric field-responsive deformation mismatch, phase transformation-induced strain mismatch, swelling or dehydration mismatch, osmotic pressure, and environmental pH variation.

12. The method of claim 10, wherein the predetermined parameter is selected from the group consisting of buckling stress, buckling amplitude, buckling shape and buckling wavelength.

13. The method of claim 10, wherein the three-dimensional ordered buckle pattern spontaneously forms a three-dimensional structure selected from the group consisting of a gear and a coil.

14. The method of claim 10, wherein the buckle pattern comprises a pattern to increase wetting properties of a nanopore.

15. A system for creating and self-assembling a three-dimensional buckle pattern in a film having at least one deformation property, comprising:
a substrate, bonded to the film and having at least one deformation property which is different than the at least one film deformation property; and
means for altering the at least one deformation property of the substrate and/or the at least one deformation property of the film according to one or more tunable parameters to thereby cause the film to buckle in a three dimensional pattern.

16. The system of claim 15, wherein the substrate comprises a substrate having a shape selected from the group consisting of a curved plane, cylinder, sphere, hemisphere, spheroid, cone, and combinations thereof.

17. The system of claim 15, wherein the substrate comprises a substrate having a cylindrical shape, and the means for altering the at least one deformation property of the substrate and/or the at least one deformation property of the film is further configured to alter the at least one deformation property of the substrate and/or the at least one deformation property of the film to thereby cause a gear shaped buckle pattern to be formed.

18. The system of claim 15, wherein the substrate comprises a substrate having a cylindrical shape, and the means for altering the at least one deformation property of the substrate and/or the at least one deformation property of the film is further configured to alter the at least one deformation property of the substrate and/or the at least one deformation property of the film to thereby cause a spring shaped buckle pattern to be formed.

19. The system of claim 15, wherein the substrate comprises a substrate having a hemispheric shape and the means for altering the at least one deformation property of the substrate and/or the at least one deformation property of the film is configured to alter the at least one deformation property of the substrate and/or the at least one deformation property of the film to thereby cause a ribbon shaped buckle pattern to be formed.

20. The system of claim 15, wherein the means for altering is configured to alter the at least one deformation property of the substrate and/or the at least one deformation property of the film by one or more of differential growth, thermal expansion mismatch, electric field-responsive deformation mismatch, phase transformation-induced strain mismatch, swelling or dehydration mismatch, osmotic pressure, and environmental pH variation.
